(19) United States
(12) Patent Application Publication
(10) Pub. No.: US 2026/0138464 A1
(43) Pub. Date: May 21, 2026

(54) SYSTEM AND METHOD FOR AUTONOMOUS ENGINE AND FUEL EFFICIENCY TUNING OF A TRAILER

(71) Applicant: Range Energy Inc., Mountain View, CA (US)

(72) Inventors: Ali Javidan, Sunnyvale, CA (US); Bryan Booth, San Mateo, CA (US); Ryan Flatland, Redwood City, CA (US); Collin MacGregor, Redwood City, CA (US); Theodore DeGuzman, Mountain View, CA (US)

(21) Appl. No.: 19/394,394

(22) Filed: Nov. 19, 2025

Related U.S. Application Data
(60) Provisional application No. 63/722,304, filed on Nov. 19, 2024.

(51) Int. Cl. B60L 15/20

(52) U.S. Cl. CPC B60L 15/2045; B60L 2200/28; B60L 2240/12; B60L 2240/26; B60L 2240/423; B60L 2240/441; B60L 2240/443; B60L 2240/54; B60L 2240/642; B60L 2240/70

(57) ABSTRACT

One variation of a system includes a trailer motor configured to install on a trailer and output torque to and regeneratively brake a driven axle; a battery configured to supply electrical energy to the trailer motor receive electrical energy from the trailer motor during regenerative braking; an external communication adapter configured to output signals representing operational data of a tow vehicle pulling the trailer; and a controller. The controller is configured to: estimate an efficiency metric of the tow vehicle and the trailer; store these operational data in a set of objects correlating motor torque outputs and engine speeds with peak efficiencies; calculate a motor torque output for the trailer motor predicted to reduce a difference between the efficiency metric and a peak efficiency of the tow vehicle and the trailer; and trigger the trailer motor to output the motor torque output.

### CROSS-REFERENCE TO RELATED APPLICATIONS

This Application claims the benefit of U.S. Provisional Application No. 63/722,304, filed on 19 Nov. 2024, which is incorporated in its entirety by this reference.

This Application is related to U.S. application Ser. No. 18/941,813, filed on 8 Nov. 2024, and U.S. application Ser. No. 18/388,474, filed on 9 Nov. 2023, each of which is incorporated in its entirety by this reference.

### TECHNICAL FIELD

This invention relates generally to the field of overland trucking and, more specifically, to a new and useful system and method for autonomous engine and fuel efficiency tuning of a trailer in the field of overland trucking.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIGS. 4A and 4B are flowchart representations of one variation of the method;

FIG. 5 is a flowchart representation of one variation of the method;

FIG. 6 is a flowchart representation of one variation of the method;

FIG. 7 is a flowchart representation of one variation of the method;

FIG. 8 is a flowchart representation of one variation of the method; and

FIGS. 9A-9D are schematic representations of a system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

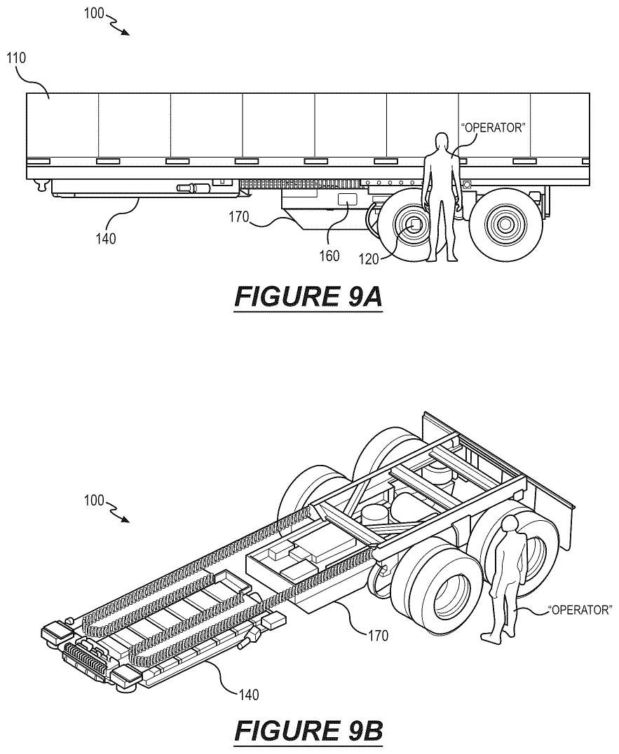

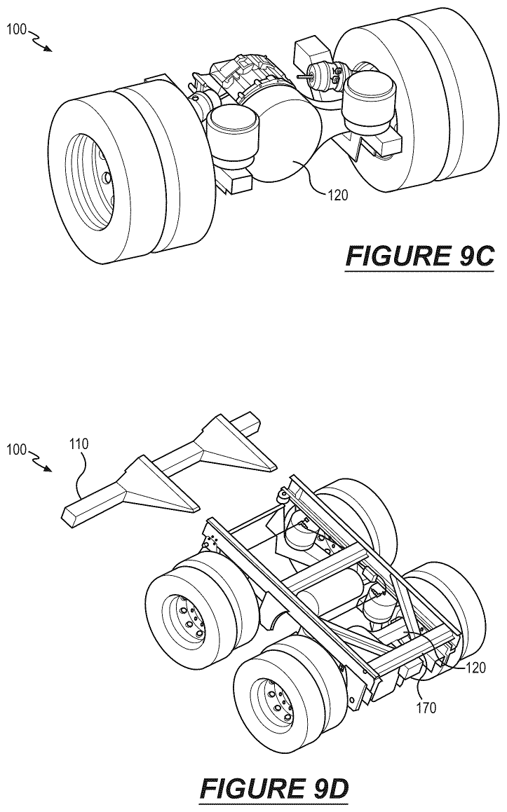

As shown in FIGS. 9A-9D, a system 100 includes: a driven axle 120 configured to install on a trailer 110 pulled by a tow vehicle; a trailer motor 130 coupled to the driven axle 120; a battery configured to install on the trailer 110; an external communication adapter 150 connected to a data port of the tow vehicle; and a controller 160.

The trailer motor 130 is configured to: output torque to the driven axle 120; and regeneratively brake the driven axle 120. The battery is configured to: supply electrical energy to the trailer motor 130 to drive the driven axle 120; and receive electrical energy from the trailer motor 130 during regenerative braking of the driven axle 120 by the trailer motor 130. The external communication adapter 150 is configured to output signals representing operational data of a tow vehicle engine of the tow vehicle.

The controller 160 is configured to: detect a first distance traveled by the tow vehicle and the trailer 110 and a first net energy consumption from the battery during a first time window; and detect a first fuel consumption and a first engine speed of the tow vehicle engine during the first time window based on a first signal output by the external communication adapter 150. The controller 160 is also configured to estimate a first efficiency metric of the tow vehicle and the trailer 110 during the first time window based on: the first distance traveled by the tow vehicle and the trailer 110; the first net energy consumption from the battery; and the first fuel consumption of the tow vehicle engine.

The controller 160 is further configured to store a first object in a set of objects correlating motor torque outputs and engine speeds with peak efficiencies of the tow vehicle and the trailer 110, the first object comprising: a first motor torque output at the trailer motor 130 during the first time window; the first efficiency metric of the tow vehicle and the trailer 110; and the first engine speed of the tow vehicle engine.

The controller 160 is also configured to: identify a first peak efficiency at the first engine speed based on objects in the set of objects including engine speeds within a threshold difference from the first engine speed; calculate a second motor torque output for the trailer motor 130 based on the set of objects, the second motor torque output predicted to reduce a difference between the first efficiency metric and the first peak efficiency at the first engine speed; and trigger the trailer motor 130 to output the second motor torque output during a second time window.

### 2. Method

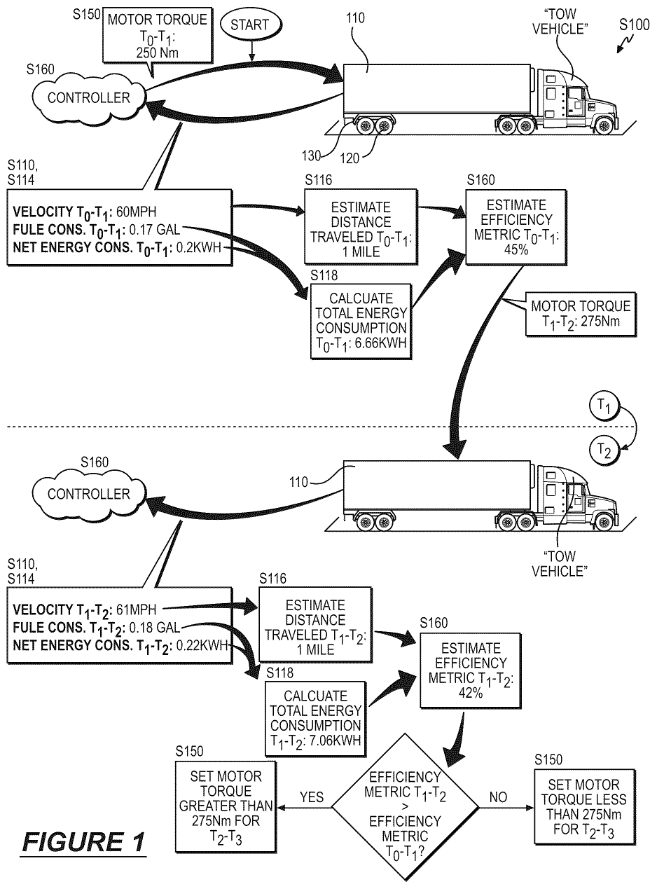

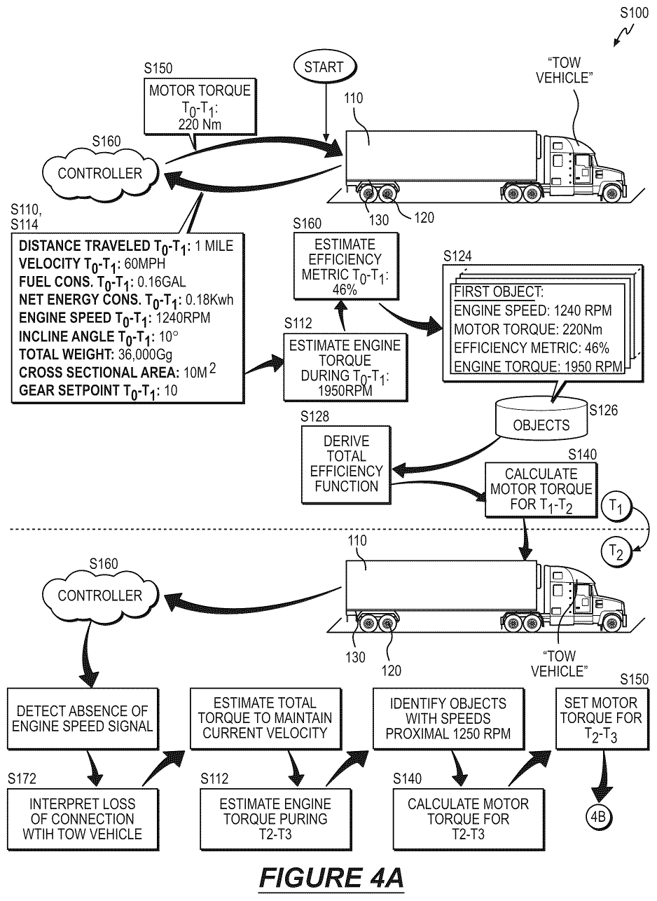

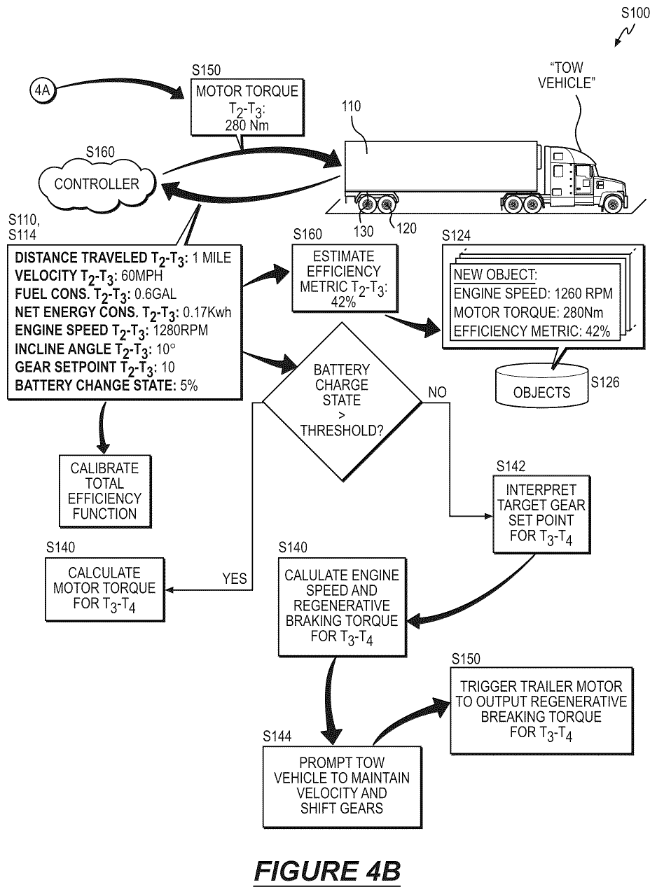

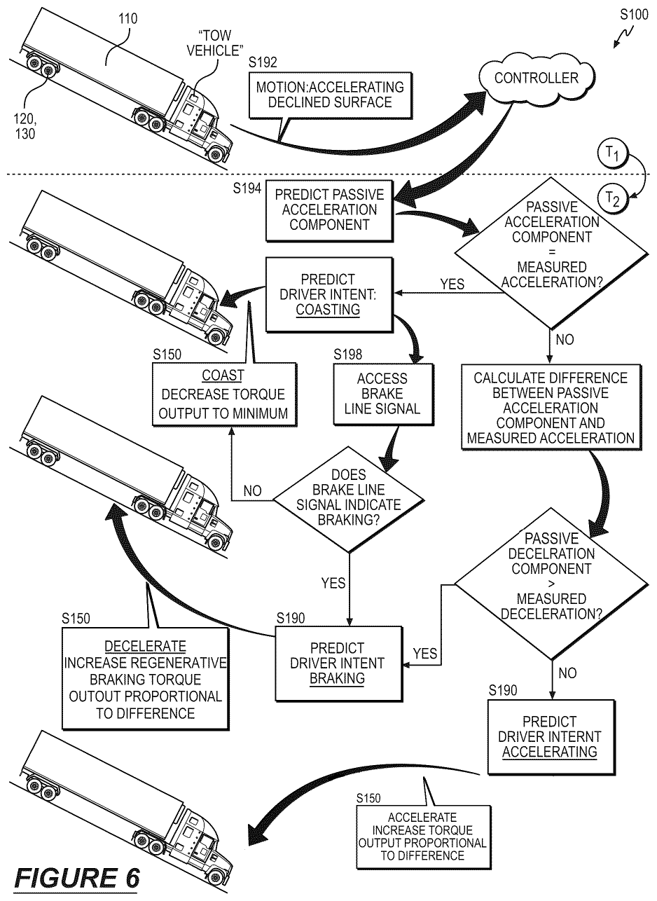

As shown in FIGS. 1-6, a method S100 includes: setting a first motor torque output at a trailer motor 130, arranged in a drive system of a trailer 110 pulled by a tow vehicle, during a first time window in Block S150; accessing a first net energy consumption from a battery of the trailer 110 during the first time window in Block S114; accessing a first fuel consumption of a tow vehicle engine of the tow vehicle and a first velocity of the tow vehicle during the first time window in Block S112; estimating a first distance traveled by the tow vehicle and the trailer 110 during the first time window based on the first velocity in Block S116; calculating a first total energy consumption of the tow vehicle and the trailer 110 during the first time window based on a first combination of the first net energy consumption from the battery of the trailer 110 and the first fuel consumption of the tow vehicle engine in Block S118; and estimating a first efficiency metric of the tow vehicle and the trailer 110 during the first time window based on the first distance traveled by the tow vehicle and the trailer 110 and the first total energy consumption of the tow vehicle and the trailer 110 in Block S160.

The method S100 also includes: setting a second motor torque output, greater than the first motor torque output, at the trailer motor 130 during a second time window in Block S150; accessing a second net energy consumption from the battery during the second time window in Block S114; accessing a second fuel consumption of the tow vehicle engine and a second velocity of the tow vehicle during the second time window in Block S112; estimating a second distance traveled by the tow vehicle and the trailer 110 during the second time window based on the second velocity in Block S116; calculating a second total energy consumption of the tow vehicle and the trailer 110 during the second time window based on a second combination of the second net energy consumption from the battery of the trailer 110 and the second fuel consumption of the tow vehicle engine in Block S118; and estimating a second efficiency metric of the tow vehicle and the trailer 110 during the second time window based on the second distance traveled by the tow vehicle and the trailer 110 and the second total energy consumption of the tow vehicle and the trailer 110 in Block S160. The method S100 further includes, in response to the second efficiency metric falling below the first efficiency metric, setting a third motor torque output, less than the second motor torque output, at the trailer motor 130 in Block S150.

### 2.1 Variation: Torque Output Modulation Based on Total Efficiency

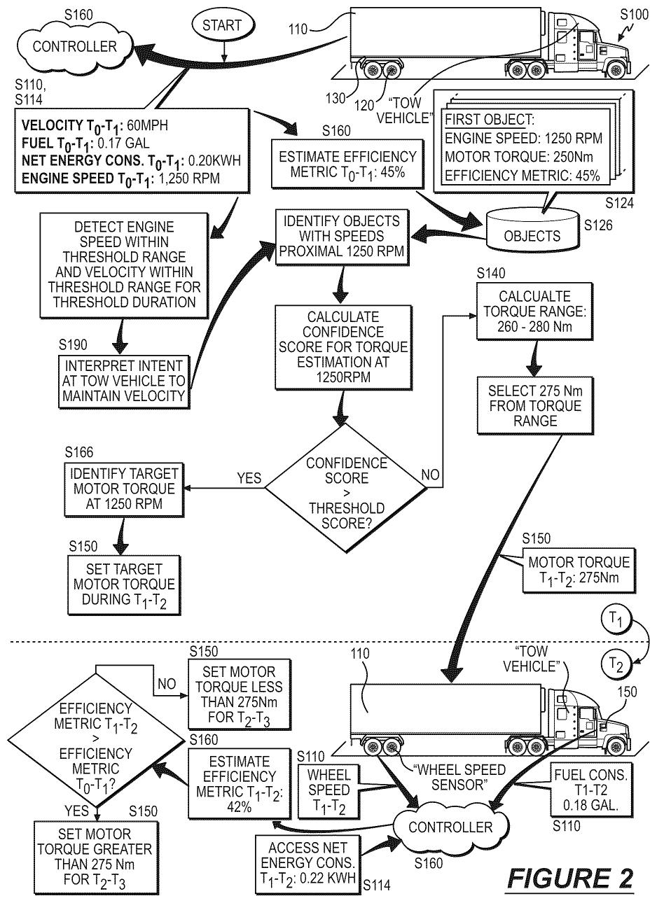

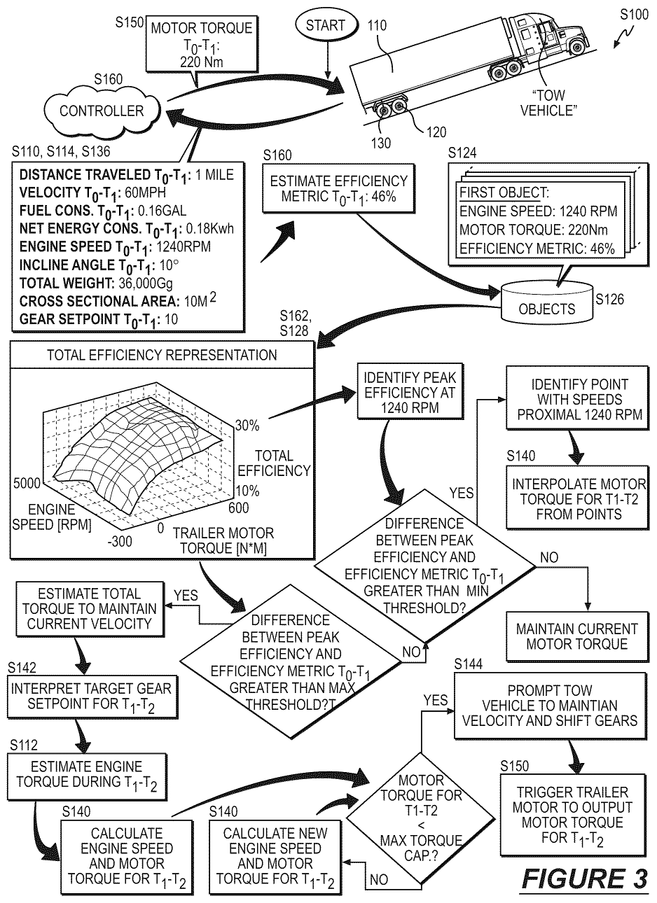

As shown in FIGS. 2 and 3, one variation of the method S100 includes: accessing a first motor torque output at a trailer motor 130, arranged in a drive system of a trailer 110 pulled by a tow vehicle, during a first time window in Block S110; accessing a first engine speed of a tow vehicle engine of the tow vehicle during the first time window in Block S112; and calculating a first efficiency metric of the tow vehicle and the trailer 110 during the first time window Block S160.

This variation of the method S100 also includes: accessing a three-dimensional virtual surface relating motor torque outputs at the trailer motor 130, engine speeds of the tow vehicle engine, and efficiency metrics of the tow vehicle and the trailer 110 in Block S162; projecting the three-dimensional virtual surface into a first two-dimensional virtual curve relating motor torque outputs and efficiency metrics at the first engine speed of the tow vehicle engine in Block S166; in response to the first efficiency metric falling below a first peak efficiency for the tow vehicle and the trailer 110 for the first engine speed, calculating a first target motor torque output for the first engine speed based on the first two-dimensional virtual curve; and, in response to the first motor torque output falling below the first target motor torque output, based on the first two-dimensional virtual curve, calculating a second motor torque output for the trailer motor 130 during a second time window in Block S152.

This variation of the method S100 also includes: accessing a second engine speed of the tow vehicle engine of the tow vehicle during the second time window in Block S112; and calculating a second efficiency metric of the tow vehicle and the trailer 110 during the second time window in Block S160.

This variation of the method S100 also includes: projecting the three-dimensional virtual surface into a second two-dimensional virtual curve relating motor torque outputs and efficiency metrics at the second engine speed of the tow vehicle engine in Block S166; in response to the second efficiency metric falling below a second peak efficiency for the tow vehicle and the trailer 110 for the second engine speed, calculating a second target motor torque output for the second engine speed based on the second two-dimensional virtual curve; and, in response to the second motor torque output exceeding the second target motor torque output, based on the second two-dimensional virtual curve, calculating a third motor torque output for the trailer motor 130 during a third time window in Block S152.

### 2.2 Variation: Torque Output Modulation Based on Engine Efficiency

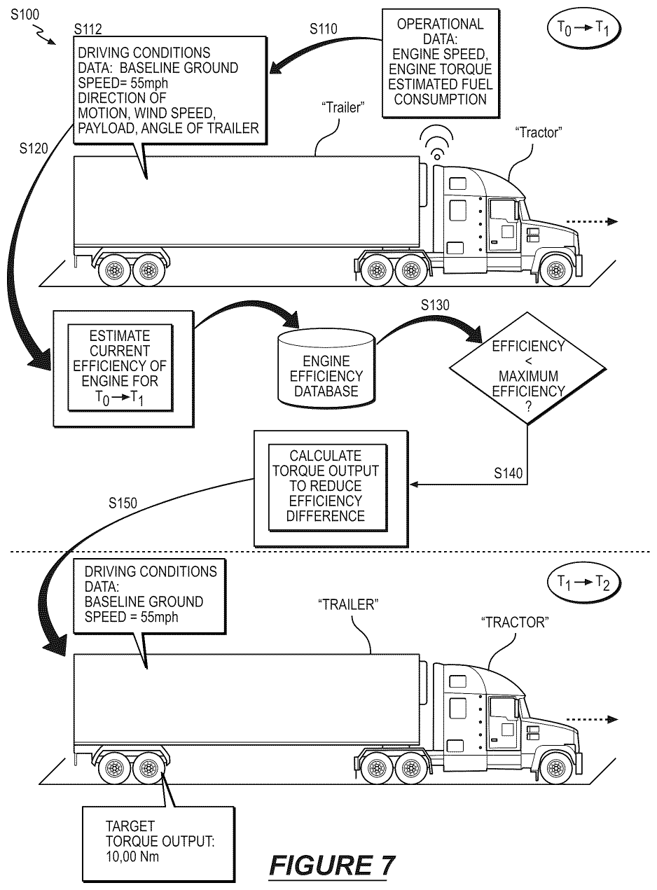

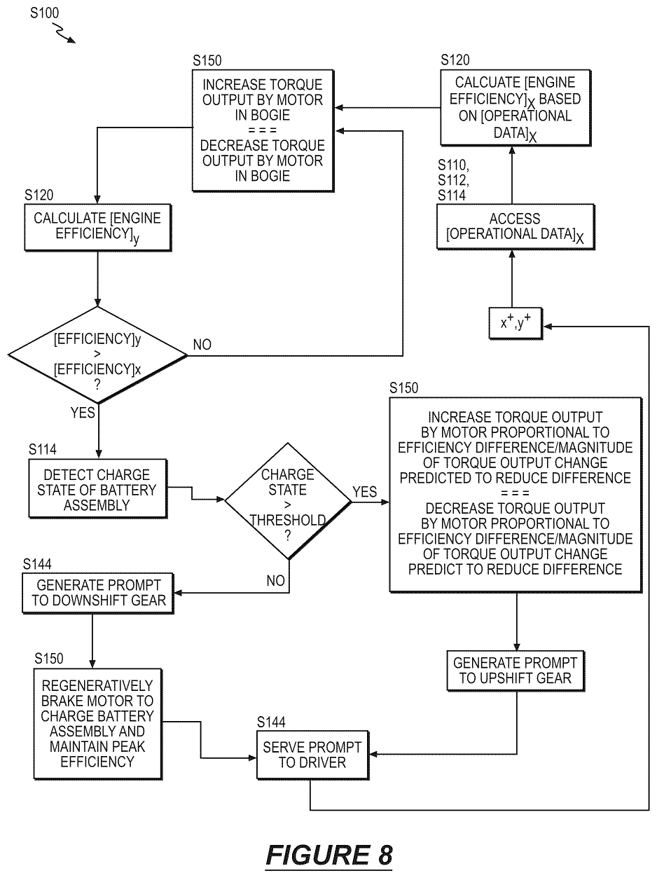

As shown in FIGS. 7 and 8, one variation of the method S100 includes: accessing a first engine speed and a first fuel consumption of an engine arranged in a tow vehicle, coupled to a trailer 110, at a first time via an external communication adapter 150 connected to a data port of the tow vehicle in Block S110; accessing a first engine torque output by the tow vehicle engine at the first time; detecting a first direction of motion of the trailer 110 at approximately the first time in Block S112; estimating a first efficiency of the tow vehicle engine at approximately the first time based on the first engine speed, the first fuel consumption, and the first engine torque output of the tow vehicle engine in Block S120; detecting a difference between the first efficiency and a maximum efficiency of the tow vehicle engine at the first engine speed in Block S130; calculating a target motor torque output, in the first direction of motion, predicted to reduce the difference between the first efficiency and the maximum efficiency of the tow vehicle engine at the first engine speed in Block S140; and triggering a trailer motor 130, coupled to a driven axle 120 in a bogie 170 of the trailer 110, to increase torque output to the target torque output in Block S150.

### 2.3 Variation: Regenerative Torque Output+Gear Shift Feedback

One variation of the method S100 includes: accessing a first engine speed and a first fuel consumption of the tow vehicle engine at a first time via the external communication adapter 150 in Block S110; accessing a first engine torque output by the tow vehicle engine at the first time; detecting a first direction of motion of the trailer 110 and a first charge state of a battery assembly 140 arranged below the floor of the trailer 110 in Block S112; estimating a first efficiency of the tow vehicle engine at approximately the first time based on the first engine speed, the first fuel consumption, and the first engine torque output of the tow vehicle engine in Block S120; and detecting a first difference between the first efficiency and the maximum efficiency of the tow vehicle engine at the first engine speed in Block S130.

This variation of the method S100 further includes, in response to the first charge state of the battery assembly 140 falling below a threshold charge state: triggering the trailer motor 130 to disable motor torque output in the first direction of motion in Block S132; calculating a change of gear and a target regenerative braking torque output, opposite the first direction of motion, to reduce the first difference between the first efficiency and the maximum efficiency of the tow vehicle engine at the first engine speed in Block S142; prompting an operator of the tow vehicle to maintain the first speed and downwardly shift gears according to the change of gear via an operator interface in Block S144; and triggering the trailer motor 130 to increase regenerative braking torque output to the target regenerative braking torque output and to recharge the battery assembly 140 in Block S150.

### 2.4 Variation: Empirical Efficiency Control Validation

As shown in FIG. 8, one variation of the method S100 includes: accessing a first engine speed and a first fuel consumption of the tow vehicle engine at a first time via the external communication adapter 150 in Block S110; accessing a first engine torque output by the tow vehicle engine at the first time; estimating a first efficiency of the tow vehicle engine at approximately the first time based on the first engine speed, the first fuel consumption, and the first engine torque output of the tow vehicle engine in Block S120; detecting a first difference between the first efficiency and the maximum efficiency of the tow vehicle engine at the first engine speed in Block S130; and, in response to detecting the tow vehicle moving at a ground speed within a threshold speed range for more than a threshold time duration, calculating a first change in torque output proportional to the first difference in Block S140 and triggering the trailer motor 130 to adjust torque output according to the change in torque output in Block S150.

This variation of the method S100 further includes: accessing a second engine speed and a second fuel consumption of the tow vehicle engine at a second time via the external communication adapter 150 in Block S110; accessing a second engine torque output by the tow vehicle engine at the second time; estimating a second efficiency of the tow vehicle engine at approximately the second time based on the second engine speed, the second fuel consumption, and the second engine torque output of the tow vehicle engine in Block S120; detecting a second difference between the first efficiency and the maximum efficiency of the tow vehicle engine at the second engine speed in Block S130; and, in response to the second efficiency exceeding the first efficiency of the tow vehicle engine, calculating a second change in torque output proportional to the second difference in Block S140 and triggering the trailer motor 130 to adjust torque output according to the second change in torque output in Block S150.

### 2.5 Computer Systems

The method S100 is described herein as executed by a controller 160 arranged within the trailer 110 to generate and store efficiency representations locally. However, the method S100 can be executed by a controller 160 configured to: transmit efficiency representations to a remote computer system (e.g., a remote server, a cloud-based database); and execute Blocks of the method S100 based on efficiency representations received from the remote computer system.

Furthermore, the method S100 is described herein as executed by a controller 160 to generate efficiency representations based solely on operational data collected during drive routes traversed by a particular tow vehicle-trailer combination. However, the method S100 can be executed by a controller 160 configured to access aggregated efficiency representations from a remote computer system computer system, the aggregated efficiency representations derived from operational data collected across a fleet of trailers 110 coupled to similar tow vehicle types.

### 2.6 Tow Vehicle Powertrain

The method S100 is described herein as executed by a controller 160 to maximize efficiency of a tow vehicle-trailer including a tow vehicle with a diesel engine. However, the method S100 can be executed by a controller 160 to maximize efficiency of a tow vehicle-trailer including a tow vehicle with alternative powertrain configurations, such as: a battery electric powertrain; a hydrogen fuel cell electric powertrain; a compressed natural gas engine; a gasoline engine; or a hybrid powertrain combining an internal combustion engine and electric motor.

Furthermore, the method S100 is described herein as executed by a controller 160 to calculate motor torque outputs that maximize total efficiency of the tow vehicle-trailer. However, for tow vehicle-trailer combinations including a battery electric tow vehicle, the method S100 can be executed by a controller 160 to calculate motor torque outputs that: balance total efficiency against relative depletion rates of the tow vehicle battery and the trailer battery; and extend total range of the tow vehicle-trailer by operating at slightly reduced efficiency to prevent premature depletion of the tow vehicle battery.

In one example, the controller 160 can: estimate a first state-of-charge of a tow vehicle battery of a battery electric tow vehicle; estimate a second state-of-charge of the trailer battery; and, in response to the first state-of-charge falling below the second state-of-charge by more than a threshold difference (e.g., 20%, indicating the tow vehicle battery is depleting faster than the trailer battery), calculate a target motor torque output that increases energy consumption from the trailer battery at a rate exceeding a rate predicted to maximize total efficiency. Therefore, in this example, the controller 160 can intentionally operate the tow vehicle-trailer at slightly reduced efficiency (e.g., by increasing trailer motor torque output beyond the peak efficiency value) to shift energy consumption from the tow vehicle battery to the trailer battery, thereby preventing premature depletion of the tow vehicle battery and extending total range of the tow vehicle-trailer despite operating at lower instantaneous efficiency.

### 3. Applications

Generally, Blocks of the method S100 can be executed by a controller 160 within an electric trailer towed by a tow vehicle (i.e., a “tow vehicle-trailer”): to access real-time data—such as an engine speed of the tow vehicle, a throttle position of the tow vehicle, a brake position of the tow vehicle, a wheel speed of the trailer 110, and/or a charge state of the battery assembly 140—associated with the tow vehicle; to derive a current efficiency of the tow vehicle engine in the tow vehicle at a constant ground (or wheel) speed of the tow vehicle-trailer; and to autonomously modulate torque output at an electrified driven axle on the trailer 110 to converge on a peak engine efficiency (or “maximum engine efficiency”) over short time intervals (e.g., ten seconds, thirty seconds) and thus, reduce global fuel consumption by the tow vehicle-trailer. Therefore, the controller 160 can implement closed-loop controls to automatically adjust torque output and regenerative braking settings (e.g., a regenerative torque output) by a motor arranged in a bogie 170 below a floor of the trailer 110 in order to rapidly achieve and then maintain this maximum engine efficiency.

In particular, the system 100 can include or interface with an external communication adapter 150 (e.g., a dongle, a connector, a peripheral device) configured to couple to a 6Pin, 9Pin, OBDII, or other diagnostic port and to transfer operational data associated with the tow vehicle to the controller 160 within the electric trailer via wireless or wired communication. Accordingly, the controller 160 can: receive operational data associated with the tow vehicle (e.g., an engine speed, a throttle position, a wheel speed, an engine torque, an estimated fuel consumption, a gear position) over a period of time (e.g., ten seconds) via the external communication adapter 150; and receive driving conditions data associated with the trailer 110 (e.g., a direction of motion, a payload on the driven axel of the trailer 110, environmental conditions) during this period of time via sensors arranged in the trailer 110.

Furthermore, the controller 160 can: identify a baseline combination speed of the tow vehicle-trailer (i.e., detect the tow vehicle moving at a ground (or wheel) speed within a threshold speed range for more than a threshold time duration); estimate a current efficiency of the tow vehicle engine (i.e., a percentage of energy in the fuel resulting in torque output by the tow vehicle engine) based on these data; incrementally modulate (e.g., increase or decrease) the torque output by the electrified driven axle; monitor the operational data associated with the tow vehicle and the driving conditions data associated with the trailer 110 during a next period of time at this torque output; and recalculate the current efficiency of the tow vehicle engine based on these data. Accordingly, if the new current efficiency is greater than the last efficiency of the tow vehicle engine, the controller 160 can further increase the torque output by the electrified driven axle proportional to this difference. Conversely, if the new current efficiency is less than the last efficiency of the tow vehicle engine, the controller 160 can incrementally decrease the torque output by the electrified driven axle proportional to this difference. The controller 160 can further fine-tune (e.g., increase or decrease) the torque output by the electrified driven axle in order to achieve a peak efficiency of the tow vehicle engine and thus, a fuel efficiency of the tow vehicle-trailer.

Additionally, the controller 160 can detect a charge state of a battery assembly 140 arranged below the trailer 110 and a gear position of the tow vehicle engine in the tow vehicle based on data transferred from the external communication adapter 150 and sensors arranged in the trailer 110. If the charge state of the battery assembly 140 is less than a threshold (e.g., 30%, 40%), the controller 160 can modulate the regenerative braking torque output by the electrified driven axle to recharge the battery assembly 140 and set a target gear position (e.g., to increase or decrease engine speed) to maintain the peak efficiency of the tow vehicle engine at the baseline combination speed of the tow vehicle-trailer. The controller 160 can further interface with a display accessible by an operator (e.g., driver) of the tow vehicle-trailer to send feedback to the operator (e.g., prompt the operator to shift the gear to the target gear position).

Therefore, the controller 160 can fine-tune torque output by an electrified driven axle on a trailer 110 to autonomously derive a peak efficiency of an engine based on direct communication with the tow vehicle via the external communication adapter 150 and signals from a small quantity of sensors arranged within the trailer 110. Additionally, the controller 160 can modulate regenerative braking torque output by the electrified driven axle to maintain the peak engine efficiency, efficiently recharge the battery assembly 140, and thereby: extend a duration (e.g., battery life) of the battery assembly 140 for a long-range haul by a tow vehicle-trailer; reduce fuel consumption by the tow vehicle; and improve global fuel efficiency by the tow vehicle-trailer.

### 3.1 Torque Output Modulation Based on Total Tow Vehicle-Trailer Efficiency

Additionally or alternatively, Blocks of the method S100 can be executed by the controller 160 within the electric trailer: to access operational data (e.g., engine speed, trailer motor torque, combined fuel and battery consumption) of the tow vehicle-trailer during a drive route; to estimate a current total efficiency metric of the tow vehicle-trailer based on these data; to incrementally modulate (e.g., increase or decrease) the torque output by the electrified driven axle; to monitor the operational data associated with the tow vehicle and the driving conditions data associated with the trailer 110 during a next period of time at this torque output; to recalculate the current total efficiency metric of the tow vehicle engine based on these data; and to autonomously modulate torque output at the electrified driven axle on the trailer 110 to converge on a peak total efficiency metric over short time intervals (e.g., ten seconds, thirty seconds) and thus, reduce fuel consumption (e.g., liquid fuel) by the tow vehicle and battery consumption by the trailer 110. In particular, if the new current total efficiency metric is greater than the last total efficiency metric, the controller 160 can further increase the torque output by the electrified driven axle proportional to this difference. Conversely, if the new current total efficiency metric is less than the last total efficiency metric, the controller 160 can incrementally decrease the torque output by the electrified driven axle proportional to this difference. The controller 160 can further fine-tune (e.g., increase or decrease) the torque output by the electrified driven axle in order to achieve a peak efficiency of the tow vehicle-trailer and thus, a total efficiency of the tow vehicle-trailer.

Furthermore, the controller 160 can: access operational data (e.g., engine speed, trailer motor torque, combined fuel and battery consumption) of the tow vehicle-trailer during a drive route while executing perturbation testing across varying engine speeds and load conditions; aggregate data points associating specific trailer torque outputs and engine speeds with measured system efficiency metrics; transform these data into an efficiency representation that maps the relationship between engine operating conditions, trailer torque contributions, and resulting system-level fuel economy; and calculate a new target motor torque output for the trailer motor 130 during a subsequent time window based on the total efficiency representation and a new engine speed of the tow vehicle engine during a subsequent time window.

Therefore, the controller 160 can fine-tune torque output by an electrified driven axle on a trailer 110 to autonomously derive a peak efficiency (e.g., an instantaneous maximum grade-adjusted distance per unit of energy consumed by the tow vehicle-trailer) of the tow vehicle-trailer based on direct communication with the tow vehicle via the external communication adapter 150 and signals from a small quantity of sensors arranged within the trailer 110. Additionally, the controller 160 can modulate regenerative braking torque output by the electrified driven axle to maintain the peak efficiency, efficiently recharge the battery assembly 140, and thereby: extend a duration (e.g., battery life) of the battery assembly 140 for a long-range haul by a tow vehicle-trailer; reduce fuel consumption by the tow vehicle; reduce battery consumption by the trailer 110; and improve total efficiency of the tow vehicle-trailer.

### 3.2 Engine Map Generation and Traversal

In one application, the controller 160 can: access operational data (e.g., engine speed, trailer motor torque, combined fuel and battery consumption) of the tow vehicle-trailer during a drive route while executing perturbation testing across varying engine speeds and load conditions; aggregate data points associating specific trailer torque outputs and engine speeds with measured system efficiency metrics; and transform these data into an efficiency representation (e.g., a three-dimensional virtual surface, a matrix, a manifold) that maps the relationship between engine operating conditions, trailer torque contributions, and resulting system-level fuel economy.

In particular, the controller 160 can generate a three-dimensional virtual surface representing total efficiency as a function of engine speed and engine torque output. The controller 160 can construct this three-dimensional virtual surface by: estimating engine torque output by the tow vehicle engine during each time window based on total torque required to maintain constant vehicle speed (accounting for incline angle, aerodynamic drag, rolling resistance) minus trailer motor torque contribution; plotting data points in three-dimensional space with axes representing engine speed (e.g., 1,500-2,500 RPM), engine torque output (e.g., 400-1,200 Nm), and measured total efficiency (e.g., 28%-38%); and fitting a continuous surface (e.g., a best-fit surface, a convex hull) to these points to create a searchable total efficiency representation.

For example, the controller 160 can: record efficiency data points during operation across varying engine speeds, load conditions, and terrain profiles; plot each point in three-dimensional space according to the corresponding engine speed, calculated engine torque output, and measured total efficiency; and interpolate a continuous surface between these points to enable efficiency prediction at any combination of engine speed and engine torque within the characterized range.

The controller 160 can then implement this efficiency representation to: access current engine speed from the external communication adapter 150; calculate total torque required to maintain current vehicle speed based on measured velocity, incline angle, vehicle weight, and cross-sectional area; subtract current trailer motor torque output from total required torque to derive current engine torque output; query the three-dimensional virtual surface to identify peak efficiency engine torque at current engine speed; calculate target adjustment to trailer motor torque output as the difference between current engine torque and peak efficiency engine torque; and modulate trailer motor torque output by this difference to shift the tow vehicle engine operating point toward peak efficiency.

More specifically, the controller 160 can implement the same efficiency map across varying operational conditions (e.g., changes in payload weight, road incline, or aerodynamic drag) by recalculating required total torque for current conditions and adjusting trailer motor contribution accordingly (i.e., without requiring map regeneration). For example, when ascending a steep grade requiring 2,800 Nm total torque at 60 mph with engine at 1,800 RPM, the controller 160 can: query the three-dimensional virtual surface to identify that peak efficiency at 1,800 RPM occurs at 1,200 Nm engine torque; calculate required trailer motor contribution of 1,600 Nm (2,800 Nm total minus 1,200 Nm engine); and trigger the trailer motor 130 to output torque, thereby maintaining engine at peak efficiency despite increased load demand.

Additionally, the controller 160 can continuously refine the three-dimensional virtual surface by plotting newly-measured data points captured during operation (e.g., during perturbation testing along the drive route) and re-fit the convex hull or update local interpolation weights to reflect the current set of points. In particular, by capturing and plotting these newly-measured data points, the controller 160 can continuously adapt the total efficiency representation to gradual changes in vehicle performance over time, such as engine wear, tire replacement, or temperature variations.

### 4. System

As shown in FIGS. 9A-9D, the system 100 includes: a trailer 110; a bogie 170; a battery assembly 140; an external communication adapter 150; and a controller 160. The trailer 110 includes: a set of rails; a bogie 170; a motor; a right wheel; a left wheel; and landing gear. In one implementation, the trailer 110 includes: a floor; a left rail coupled to the floor, extending parallel to and laterally offset from a longitudinal centerline of the trailer 110, and defining a first array of engagement features distributed along the left rail and longitudinally offset by a pitch distance; a right rail coupled to the floor, extending parallel to and laterally offset from the longitudinal centerline of the trailer 110 opposite the left rail, and defining a second array of engagement features distributed along the right rail and longitudinally offset by the pitch distance; and a bogie 170.

### 4.1 Bogie+Battery Assembly

Generally, the bogie 160 includes a chassis, a driven axle 120 suspended from the chassis, and a motor 130 coupled to the driven axle 120, similar to the bogie 160 described in U.S. application Ser. No. 18/941,813, filed on 8 Nov. 2024, and U.S. application Ser. No. 18/388,474, filed on 9 Nov. 2023, each of which is incorporated in its entirety by this reference.

In one implementation, the bogie 170 includes: a chassis configured to transiently install on a left rail and a right rail of a trailer 110 over a range of longitudinal positions; a set of latches configured to transiently engage a subset of engagement features, in the first array of engagement features on the left rail and in the second array of engagement features on the right rail, to retain the bogie 170 below the floor of the trailer 110; a driven axle 120 suspended from the chassis; and a motor coupled to the driven axle 120.

In one variation, the driven axle 120 is supported by an axle housing, suspended from the chassis, and includes a left driven wheel and a right driven wheel. The axle housing further encapsulates a motor mounted to the driven axle 120 and is configured to protect the driven axle 120 and the trailer motor 130 when the bogie 170 is adjusted along the floor of the trailer 110 and/or removed for service. In this variation, the trailer motor 130 is configured to drive the left driven wheel and the right driven wheel and thus, output torque in the direction of motion of the trailer 110 in a tow mode (e.g., propulsion assist mode). The trailer motor 130 is further configured to regeneratively brake the driven axle 120 (e.g., output torque opposite the direction of motion of the trailer 110) in a regenerative braking mode.

In another variation, the bogie 170 includes a passive axle, suspended from the chassis, adjacent the driven axle 120 and includes a left passive wheel and a right passive wheel. In this variation, the left passive wheel and the right passive wheel are configured to assist motion of the trailer 110 when the left driven wheel and the right driven wheel are driven by the trailer motor 130 in the tow mode.

Furthermore, the system 100 can include a battery assembly 140 configured to transiently install on the trailer 110 over a range of longitudinal positions and electrically couple to the bogie 170 by a power cable (or integrated directly with the chassis of the bogie 170) in order to supply power to the trailer motor 130. In one variation, the battery assembly 140 can include a set of modular batteries configured to engage with each other and fit within a battery frame (e.g., a stressed frame). The battery frame is configured to fit below a standard floor of a trailer 110 between the left rail and the right rail and thus, enable a user to quickly and repeatably install the battery assembly 140 or the set of modular batteries below a standard floor of any trailer. The set of modular batteries enables a user to selectively adjust the battery capacity of the battery assembly 140 as a function of a predicted distance traveled by the trailer 110, a weight distribution of the trailer 110, a type of the trailer 110 (e.g., a dry van trailer, a refrigerated trailer), and/or a length of the trailer 110 (e.g., 20 feet, 40 feet, 48 feet, 53 feet, 60 feet).

However, each modular battery in the battery assembly 140 can define any other shape and couple to the trailer motor 130 in any other way.

### 4.2 Sensors

The system 100 can include: a set of sensors - such as inertial sensors (e.g., an IMU, an accelerometer, a gyroscope), pressure sensors, tilt sensors (e.g., an inclinometer), and/or optical sensors (e.g., a one-dimensional depth sensor, a LIDAR sensor, an RGB camera)—arranged on the trailer 110 and configured to output signals representing conditions of the trailer 110 to the controller 160.

In one variation, the system 100 can include a set of wheel speed sensors configured to output signals representing inertial conditions of the trailer 110—such as speed, direction of motion, or acceleration of the trailer 110—relative to a ground surface below the trailer 110. Each wheel speed sensor is coupled to a corresponding driven wheel of the trailer 110 and/or a passive wheel of the trailer 110 and transmits these signals to the controller 160.

In one variation, the system 100 can include a set of pressure sensors configured to output signals corresponding to air pressure in brake lines of the trailer 110. In one example, the system 100 includes a pressure sensor coupled to the driven axle 120 and configured to output signals corresponding to air pressure of air bags in an air-ride suspension system coupled to the driven axle 120 and transmit these signals to the controller 160. In yet another example, the system 100 includes a pressure sensor configured to couple to a signal brake line and output signals corresponding to air pressures at the signal brake line, extending from the tow vehicle to the trailer 110, from an air supply of the tow vehicle.

### 4.3 External Communication Adapter

The system 100 further includes: an external communication adapter 150 (e.g., a plug, a dongle, a peripheral device) configured to: couple to a 6Pin, 9Pin, OBDII or other diagnostic or data port of a tow vehicle; access operational data of the tow vehicle; and transfer operational data, associated with the tow vehicle, to a wireless communication module arranged on the trailer 110.

In one implementation, the external communication adapter 150: couples to a data port of a tow vehicle; initiates a handshake protocol with the tow vehicle to establish a secure connection with the wireless communication module arranged on the trailer 110; receives operational data - such as engine data, sensor data, fuel consumption data, driver intent data, or other diagnostic data - from an electronic control unit(s) or electronic computer module(s) in the tow vehicle via the data port; and transmits these operational data to the wireless communication module arranged on the trailer 110, the controller 160, or a computer system via a wireless communication protocol (e.g., Wi-Fi, Bluetooth).

In another implementation, the external communication adapter 150 defines a first end configured to couple to a diagnostic port arranged on a tow vehicle and a second end configured to couple to a data port arranged on the trailer 110. The external communication adapter 150 then: receives operational data—such as engine data, sensor data, fuel consumption data, driver intent data, or other diagnostic data—via the diagnostic port; and transfers these operational data to the wireless communication module arranged on the trailer 110 or the controller 160 via a wired communication protocol (e.g., SAE J1939).

### 4.4 Controller

The controller 160 is coupled to sensors within the trailer 110 and executes the methods and techniques described below: to access data transferred by the external communication adapter 150 coupled to a diagnostic port of a tow vehicle; to decrypt these data; to detect a baseline state (e.g., a steady-state) of the tow vehicle—such as an engine speed, a throttle position, a brake position, and/or a fuel consumption of the tow vehicle—based on these data at an initial time; to derive an initial engine efficiency of the tow vehicle based on these data; and implement closed-loop controls to incrementally modulate torque output by the trailer motor 130 of the trailer 110 to achieve a maximum engine efficiency by the tow vehicle (e.g., a percentage of energy in the fuel of the tow vehicle resulting in torque output) and thus a maximum fuel efficiency rate at the baseline state.

The controller 160 can further: access signals output by sensors coupled to a proximal end, a brake line, a suspension system, and wheels of the trailer 110; detect a baseline state (e.g., a steady-state) of the trailer 110—such as a speed, a direction of motion, a weight, a charge state of the battery assembly 140, and/or an incline angle of the trailer 110—based on these signals at the initial time in conjunction with the baseline state of the tow vehicle; modulate regenerative torque output by the trailer motor 130 of the trailer 110 to charge the battery assembly 140 to achieve the maximum engine efficiency by the tow vehicle at the baseline state.

Additionally, the controller 160 can: detect operational data of the tow vehicle-trailer, such as a distance traveled by the tow vehicle-trailer during a particular time window, a net energy consumption from the battery during the particular time window, a fuel consumption by the tow vehicle, and/or an engine speed of the tow vehicle engine; estimate an efficiency metric of the tow vehicle-trailer during the time window based on these data; and implement closed-loop controls to incrementally modulate torque output by the trailer motor 130 to achieve a peak efficiency by the tow vehicle-trailer (e.g., a maximum grade-adjusted distance traveled per unit of energy consumed by the tow vehicle-trailer). In one example, the controller 160: accesses a first signal output by the external communication adapter 150; detects a fuel consumption of the tow vehicle engine and an engine speed of the tow vehicle engine during a time window based on the first signal; accesses a second signal output by a wheel speed sensor arranged on a wheel of the trailer 110 and representing an angular velocity of the wheel during the time window; and detects a velocity of the tow vehicle during the time window based on the angular velocity of the wheel and a diameter of the wheel.

Additionally, the controller 160 can: store these data in a set of objects correlating motor torque outputs and engine speeds with peak efficiencies of the tow vehicle-trailer; identify a peak efficiency at a particular engine speed based on the set of objects (or a “total efficiency representation”); calculate a new motor torque output for the trailer motor 130 predicted to reduce a difference between the efficiency metric and the peak efficiency at the particular engine speed; and trigger the trailer motor 130 to output the new motor torque output during the next time window.

Additionally, the controller 160 can: interface with a graphical display accessible by a driver of the tow vehicle; and serve feedback (e.g., a gear shift prompt, a torque output notification, a regenerative torque output notification) to the driver via the graphical display in order to maintain the maximum engine efficiency by the tow vehicle at the baseline state.

### 5. Setup Period+Handshake Protocol

Furthermore, the user (e.g., an operator, a driver, a yard manager) may couple the external communication adapter 150, such as a dongle, to a data port of the tow vehicle. The external communication adapter 150 can then initiate a handshake protocol with a network associated with the tow vehicle to establish a secure connection prior to transferring data during the torque output assist mode.

In one implementation, the external communication adapter 150 initiates a handshake protocol with the controller 160. The controller 160 then: triggers the wireless communications module, arranged on the trailer 110, to transmit wireless interrogation signals to nearby devices (e.g., within a threshold distance of the trailer 110); accesses an identifier broadcast by the external communication adapter 150; and, in response to identifying the identifier in an identifier database of approved devices, establishes a secure wireless connection with an external communication adapter 150 to transfer operational data from the data port of the tow vehicle.

In one variation, the external communication adapter 150 can include a radio frequency identification tag (e.g., an RFID tag) or a near-field communication chip (e.g., an NFC chip) and a user may access a device (e.g., a mobile phone, a tablet, a computing device) configured to read a particular radio frequency associated with the RFID tag or the NFC chip and locate the device within a threshold distance of the external communication adapter 150. The device can then implement a handshake protocol with the wireless communication module on the trailer 110 and the external communication adapter 150 can establish a wireless connection with the network of the tow vehicle. Upon completion of the handshake protocol, the external communication adapter 150 can receive operational data from the data port of the tow vehicle and transfer these operational data to the controller 160 via the wireless communication module arranged on the trailer 110, as further described below.

### 6. Torque Output Assist Mode

Generally, the user (e.g., an operator, a driver, a yard manager) or a machine (e.g., a forklift) couples the hitch (e.g., a fifth wheel) of a tow vehicle to a vehicle coupler arranged on the trailer 110. The controller 160 can: interpret a coupling event between the vehicle coupler and the hitch of the tow vehicle (e.g., via a signal from an IMU sensor arranged on the proximal end of the trailer 110 facing the tow vehicle coupled to the trailer 110); and, in response to interpreting the coupling event between the vehicle coupler and the hitch of the tow vehicle and in response to establishing a connection between the external communication adapter 150 and the network of the tow vehicle, enter a torque output assist mode (e.g., a tow mode, a propulsion assist mode).

### 6.1 Data Aggregation

Blocks S110 and S112 of the method S100 recite: accessing a first engine speed and a first fuel consumption of an engine at a first time via an external communication adapter 150 coupled to a data port of a tow vehicle; and detecting a first direction of motion at approximately the first time. Generally, the controller 160 can access operational data associated with the tow vehicle via the external communication adapter 150 and access driving conditions data associated with the trailer 110 via sensors during the torque output assist mode in Blocks S110 and S112.

In particular, operational data associated with the tow vehicle includes: an engine speed, a fuel flow rate, a throttle position, a brake position, an estimated engine torque, an estimated fuel consumption, an exhaust gas temperature, a gear position, tire pressure, a coolant temperature of the tow vehicle engine, a quantity of oxygen in exhaust gas, an air-fuel ratio, a wheel speed, and/or intake air temperature etc. Driving conditions data associated with the trailer 110 includes: a direction of motion, a wheel speed, a charge state of the battery assembly 140 (e.g., a status, a level, a percentage), an angle of the trailer 110 relative to a ground surface (e.g., an incline angle, a decline angle), a weight (e.g., payload) on the driven axle 120 of the trailer 110, an ambient temperature of air proximal the trailer 110, and/or a wind speed etc.

In one variation, the controller 160 receives operational data associated with the tow vehicle via the external communication adapter 150 over a time interval (e.g., thirty seconds, one minute) or data rate (e.g., once per thirty seconds, once per minute). The controller 160 further interprets driving conditions data associated with the trailer 110 from signals output by sensors coupled to the trailer 110 over the time interval. The controller 160 then stores and manipulates these data to estimate a maximum efficiency of the tow vehicle engine and thus a total efficiency of the tow vehicle-trailer (e.g., a semitruck).

### 6.2 Modeling: Engine Efficiency

Generally, as shown in FIGS. 7 and 8, the controller 160 can implement regression, machine learning, artificial intelligence, and/or other techniques to generate an engine efficiency function (or “model”) configured to directly estimate the efficiency of the tow vehicle engine of the tow vehicle as a function of (e.g., proportional to) engine speed and engine torque over time.

### 6.2.1 Engine Efficiency Plot

In one implementation, the controller 160: receives a set of signals output by the external communication adapter 150 during a drive route; interprets a series of engine speed values, a series of fuel consumption values, a series of throttle position values, and a series of gear selection values based on the set of signals; derives a series of estimated engine torque values based on the series of engine speed values, the series of fuel consumption values, and the series of gear selection values; detects a weight of the trailer 110, containing a load on the driven axle 120, via a pressure sensor; detects a series of ground (or wheel) speed values of the trailer 110 via wheel speed sensors; calculates a series of power output values of the tow vehicle during the drive route based on the series of estimated engine torque values, the series of engine speed values, and the series of throttle positions; and estimates a series of engine efficiency values of the tow vehicle during the drive route based on the series of power output values and the series of fuel consumption values.

Accordingly, the controller 160 (or computer system) can aggregate the series of engine speed values, the series of an estimated engine torque values, and the series of engine efficiency values into an engine efficiency plot. The tow vehicle engine efficiency plot (e.g., engine efficiency-versus-engine speed-versus engine torque plot) represents a relationship between engine torque, engine speed, and engine efficiency during the drive route for this particular type of tow vehicle. The controller 160 (or computer system) can then store this engine efficiency plot associated with the type of the tow vehicle in an engine efficiency database. Therefore, the controller 160 can derive relationships between operational data of a tow vehicle and driving conditions data of a trailer 110 and generate an engine efficiency plot. Based on the tow vehicle engine efficiency plot, the controller 160 can estimate a current engine efficiency or a maximum engine efficiency of the tow vehicle-trailer and derive target torque outputs to achieve and maintain the maximum engine efficiency.

### 6.2.2 Engine Efficiency Model

In another implementation, the controller 160: accesses real-time operational data of the tow vehicle—such as engine speed, engine load, fuel consumption, gear selection, throttle position, and/or brake position - via the external communication adapter 150 coupled to the port of the tow vehicle during a time interval; accesses driving conditions data of the trailer 110—such as a weight (e.g., a payload) on the driven axle 120 of the trailer 110, a wheel speed, an angle of the trailer 110 (e.g., incline angle, decline angle) relative to a ground surface, a wind speed proximal the trailer 110, and/or an ambient temperature of air proximal the trailer 110—via sensors coupled to the trailer 110 during the time interval; and transmits these data to the computer system.

Accordingly, the computer system: tracks these operational data of the tow vehicle and the driving conditions of the trailer 110 over a period of time (e.g., a drive route, one day, one week); detects a set of common engine speeds (e.g., 750 rpm, 1000 rpm, 2,000 rpm, 3,000 rpm) repeating at a high frequency of occurrence during the drive route; derives a set of relationships between operational data of the tow vehicle and the conditions of the trailer 110 at (or near) each common engine speed associated with a particular wheel speed; and generates an engine efficiency model that correlates engine speed, engine torque, and fuel conversion efficiency of the tow vehicle based on the set of relationships. The computer system then stores this engine efficiency model associated with the type of this tow vehicle in the tow vehicle engine efficiency database.

Therefore, the computer system can: derive relationships between operational data of a tow vehicle and driving conditions data of a trailer 110; generate an engine efficiency model; and input current operational data and driving conditions data into the tow vehicle engine efficiency model to estimate a current engine efficiency or a maximum engine efficiency of the tow vehicle-trailer.

### 6.2.3 Estimation: Output Torque of Engine+Engine Efficiency

Block S120 of the method S100 recites estimating a first efficiency of the tow vehicle engine based on a first engine speed of the tow vehicle engine, a first fuel consumption, and a first engine torque output of the tow vehicle engine at approximately the first time. Generally, the controller 160 can estimate an instantaneous output torque of the tow vehicle engine of the tow vehicle during a time interval, while the tow vehicle-trailer traverses along a drive route in Block S120. In particular, the controller 160 can: track conditions of the tow vehicle and the trailer 110 over a time interval; interpret a fuel flow rate, a throttle position, a ground speed (e.g., wheel speed), and a speed of the tow vehicle engine of the tow vehicle via the external communication adapter 150 coupled to the port of the tow vehicle; and derive an instantaneous output torque of the tow vehicle engine of the tow vehicle during this time interval based on these data.

In one implementation, the controller 160: retrieves the stored engine efficiency plot for an engine of an analogous engine type at (or near) the current engine speed; and queries the tow vehicle engine efficiency plot for an estimated efficiency of the tow vehicle engine during this time interval based on the current torque output of the tow vehicle engine.

In another implementation, the controller 160 inputs a current throttle position, a current engine speed, a current engine torque, a current fuel consumption, a current weight of the trailer 110, containing a load on the driven axle 120, the speed of the trailer 110, and an angle of the trailer 110 relative to the ground surface into the stored engine efficiency model. The tow vehicle engine efficiency model then generates an estimate of the efficiency of the tow vehicle engine during this time interval. However, the controller 160 can implement any other method or technique to estimate the current efficiency of the tow vehicle engine.

### 6.2.4 Controls: Torque Output Modulation

Blocks S130 and S140 of the method S100 recite: detecting a difference between the first efficiency and a maximum efficiency of the tow vehicle engine at the first engine speed; and calculating a target torque output, in the first direction of motion, predicted to reduce the difference between the first efficiency and the maximum efficiency of the tow vehicle engine at the first engine speed. Generally, in Blocks S130 and S140 the controller 160 can implement closed-loop controls to selectively trigger the trailer motor 130 to increase or decrease the torque output to identify a peak efficiency (e.g., maximum efficiency) of the tow vehicle engine and then calculate a target torque output to reduce a difference (e.g., positive or negative) between the current efficiency and the maximum efficiency of the tow vehicle engine.

In particular, the controller 160 can: interpret a current status of the tow vehicle engine based on operational data output by the external communication adapter 150; calculate a change in torque output; trigger the trailer motor 130 to adjust torque output according to the change in torque output (e.g., increase or decrease torque output in the direction of motion, increase or decrease regenerative braking torque output opposite the direction of motion); recheck the current engine status based on current operational data output by the external communication adapter 150; verify that the change in torque output improved an efficiency of the tow vehicle engine (e.g., current engine status greater than the last engine status); and, in response to improvement of the efficiency of the tow vehicle engine, expand the change in torque output by changing torque output proportional to the efficiency improvement divided by the magnitude of the change in torque output and vice versa.

In one implementation, the controller 160 can modulate the torque output by the trailer motor 130 to achieve and maintain a maximum efficiency of the tow vehicle engine. Responsive to a current estimated efficiency exceeding a previous estimated efficiency of the tow vehicle engine, the controller 160 can increase the torque output by the trailer motor 130 proportional to this difference. Conversely, responsive to the current estimated efficiency falling below the previous estimated efficiency of the tow vehicle engine, the controller 160 can decrease the torque output by the trailer motor 130 proportional to this difference.

### 6.2.5 Closed-Loop Controls: Peak Efficiency

In one variation, the controller 160 implements methods and techniques described above: to access operational data of the tow vehicle engine during a particular time interval via the external communication adapter 150; to estimate a current efficiency of the tow vehicle engine during this time interval based on the operational data; and to detect the tow vehicle moving at a ground (or wheel) speed within a threshold speed range for more than a threshold time duration.

The controller 160 then: triggers the trailer motor 130 to incrementally increase the torque output in the direction of motion of the trailer 110 at the baseline ground speed; monitors the operational data of the tow vehicle via the external communication adapter 150; recalculates the current engine efficiency of the tow vehicle engine at the baseline ground speed and the new torque output; in response to detecting a positive difference between the new engine efficiency and the previous engine efficiency, triggers the trailer motor 130 to increase the torque output, proportional to the positive difference, in the direction of motion of the trailer 110 at the baseline ground speed; monitors the operational data of the tow vehicle engine via the external communication adapter 150; recalculates the current engine efficiency of the tow vehicle engine at the constant speed and the new torque output; and, in response to the new engine efficiency approximating (e.g., matching, falling within a tolerance range of) the previous engine efficiency, identifies the new engine efficiency as a maximum engine efficiency for this tow vehicle.

Alternatively, in response to detecting a negative difference between the new engine efficiency and the previous engine efficiency, the controller 160 can trigger the trailer motor 130 to decrease the torque output, proportional to the negative difference, in the direction of motion of the trailer 110 at the baseline ground speed. The controller 160 repeats methods and techniques described above to achieve a new engine efficiency approximating (e.g., matching, falling within a tolerance range of) the previous engine efficiency and identifies the new engine efficiency as the maximum engine efficiency for this tow vehicle.

For example, the controller 160 can: access a set of operational data of a tow vehicle coupled to an electrified trailer such as an engine speed (e.g., 2,000 rpm), a baseline ground speed (e.g., 55 mph), a gear selection (e.g., ninth gear), and an estimated fuel efficiency (e.g., 5.8 mpg); derive an engine torque (e.g., 200 Nm) based on the tow vehicle engine speed, the baseline ground speed, the gear selection, and the estimated fuel efficiency; estimate a current efficiency (e.g., 30%) based on the tow vehicle engine speed and the tow vehicle engine torque; trigger the trailer motor 130 to incrementally increase torque output, such as by 2 Nm, to the driven axle 120; estimate a new current efficiency (e.g., 35%) based on the tow vehicle engine speed and the tow vehicle engine torque based on a new set of operational data of the tow vehicle at the new torque output; detect a positive difference between the current efficiency and the previous engine efficiency (e.g., +5%); and trigger the trailer motor 130 to incrementally increase torque output, such as by 5 Nm, to the driven axle 120 proportional to the positive difference.

The controller 160 can then: estimate a new current efficiency (e.g., 33%) based on the tow vehicle engine speed and the tow vehicle engine torque based on a new set of operational data of the tow vehicle at the new torque output; detect a negative difference between the current efficiency and the previous engine efficiency (e.g., −2%); trigger the trailer motor 130 to incrementally decrease torque output, such as by 2 Nm, to the driven axle 120 proportional to the negative difference; and repeat the methods and techniques described above for each other time interval and torque output adjustment to achieve a new current efficiency that approximates the previous efficiency and to define the maximum efficiency for the tow vehicle engine as this current efficiency. Therefore, the controller 160 can modulate the torque output to the driven axle 120 by triggering the trailer motor 130 to incrementally increase or decrease the torque output over time intervals (e.g., two seconds, ten seconds). The controller 160 can further monitor a change in estimated efficiency of the tow vehicle engine at each torque output by the trailer motor 130 to converge on a maximum efficiency of the tow vehicle engine.

### 6.3 Adaptive Torque Control for Tow Vehicle-Trailer Efficiency

Blocks of the method S100 recite: setting a motor torque output at the trailer motor 130 during a time window in Block S150; accessing a net energy consumption from the battery during the time window in Block S114; accessing a fuel consumption of the tow vehicle engine and a velocity of the tow vehicle during the time window in Block S112; estimating a distance traveled by the tow vehicle and the trailer 110 during the time window based on the velocity in Block S116; calculating a total energy consumption of the tow vehicle and the trailer 110 during the time window based on a combination of the net energy consumption from the battery of the trailer 110 and the fuel consumption of the tow vehicle engine in Block S118; and estimating an efficiency metric of the tow vehicle and the trailer 110 during the time window based on the distance traveled by the tow vehicle and the trailer 110 and the total energy consumption of the tow vehicle and the trailer 110 in Block S160. Generally, as shown in FIG. 1, the controller 160 can: incrementally perturb trailer motor torque output during steady-state operation; measure resulting changes in combined system efficiency of the tow vehicle and the trailer 110 (or the “tow vehicle-trailer”); and iteratively adjust torque toward settings that minimize total energy consumption per distance traveled.

In one implementation, the controller 160 can: set a first motor torque output at a trailer motor 130, arranged in a drive system of a trailer 110 pulled by a tow vehicle, during a first time window; access a first net energy consumption (e.g., 2.5 kWh) of a battery of the trailer 110 during the first time window; access a first fuel consumption (e.g., 0.8 gallons) of the tow vehicle engine of the tow vehicle and a first velocity of the tow vehicle during the first time window; and estimate a first distance (e.g., one mile) traveled by the tow vehicle and the trailer 110 during the first time window based on the first velocity.

The controller 160 can then: calculate a first total energy consumption of the tow vehicle and the trailer 110 (e.g., 30.0 kWh) during the first time window based on a first combination of the first net energy consumption from the battery of the trailer 110 and the first fuel consumption of the tow vehicle engine; and estimate a first efficiency metric of the tow vehicle and the trailer 110 (e.g., 30.0 kWh per mile, or 33% efficient) during the first time window based on the first distance traveled by the tow vehicle and the trailer 110 and the first total energy consumption of the tow vehicle and the trailer 110. The controller 160 can then iteratively perturb motor torque output and estimate resulting efficiency metrics across sequential time windows with different torque outputs to converge on motor torque outputs that minimize total energy consumption.

For example, the controller 160 can set a second motor torque output (e.g., increasing from 100 Nm to 110 Nm), greater than the first motor torque output, at the trailer motor 130 during a second time window. The controller 160 can then implement methods and techniques described above to estimate a second efficiency metric of the tow vehicle and the trailer 110 (e.g., 30.3 kWh per mile, or 32% efficient) during the second time window based on: a second distance traveled by the tow vehicle during the second time window; a second net energy consumption from the battery during the second time window; and a second fuel consumption of the tow vehicle engine during the second time window.

For example, in response to the second efficiency metric (e.g., 30.3 kWh per mile, or 32% efficient) falling below the first efficiency metric (e.g., 30.0 kWh per mile, or 33% efficient) and thus indicating degraded efficiency performance, the controller 160 can then set a third motor torque output (e.g., 105 Nm), less than the second motor torque output (e.g., 110 Nm), at the trailer motor 130 for the next time window. Alternatively, in response to the second efficiency metric (e.g., 30.8 kWh per mile, or 35% efficient) exceeding the first efficiency metric, the controller 160 can set a third motor torque output (e.g., 115 Nm), greater than the second motor torque output, at the trailer motor 130 for the next time window. Accordingly, the controller 160 can iteratively perturb trailer motor torque output to converge on a motor torque output that maximizes total efficiency of the tow vehicle-trailer (e.g., minimizes fuel consumption at the tow vehicle and battery consumption at the bogie 170).

### 6.4 Modeling: Total Tow Vehicle-Trailer Efficiency

Block S124 of the method S100 recites generating an object including: a motor torque output at the trailer motor 130 during a time window; an efficiency metric of the tow vehicle and the trailer 110 during the time window; and an engine speed of the tow vehicle engine during the time window. Block S126 of the method S100 recites storing the object in a set of objects, each object in the set of objects including a motor torque output at the trailer motor 130, an engine speed of the tow vehicle engine, and an efficiency metric of the tow vehicle and the trailer 110.

Generally, as shown in FIGS. 2-4B, the controller 160 can: access operational data (e.g., engine speed, trailer motor torque, combined fuel and battery consumption) of the tow vehicle-trailer during a drive route while executing perturbation testing across varying engine speeds and load conditions; aggregate data points associating specific trailer torque outputs and engine speeds with measured system efficiency metrics; and transform these data into an efficiency representation that maps the relationship between engine operating conditions, trailer torque contributions, and resulting system-level fuel economy. For example, the controller 160 can implement regression, machine learning, artificial intelligence, and/or other techniques to generate a total engine efficiency function (or “model”) configured to directly estimate the efficiency of the combined tow vehicle and trailer as a function of trailer motor torque output and tow vehicle engine speed.

In one implementation, the controller 160 can implement methods and techniques described above to: estimate an efficiency metric of the tow vehicle and the trailer 110 during a time window; and access an engine speed of the tow vehicle engine during the time window. The controller 160 can then generate an object that includes: the trailer motor torque output at the trailer motor 130 during the time window; the efficiency metric of the tow vehicle and the trailer 110 during the time window; and the tow vehicle engine speed of the tow vehicle engine during the time window. The controller 160 can then store this object in a set of objects that include different motor torque outputs at the trailer motor 130, engine speeds of the tow vehicle engine, and efficiency metrics of the tow vehicle and the trailer 110. Additionally, the controller 160 can repeat this process to generate a population of objects that represent efficiency metrics across a range of motor torque outputs and engine speeds.

Accordingly, the controller 160 can aggregate motor torque outputs at the trailer motor 130, efficiency metrics of the tow vehicle-trailer, and engine speed values at the tow vehicle engine into the total efficiency representation (e.g., a motor torque-versus-total efficiency metric-versus-engine speed plot) defining or representing a relationship between motor torque, efficiency of the tow vehicle-trailer, and engine speed during the drive route for this particular type of tow vehicle. The controller 160 can then store this total efficiency representation associated with the type of the tow vehicle in an engine efficiency database. The controller 160 can then implement methods and techniques described below to calculate a target motor torque output for the trailer motor 130 during a subsequent time window based on the set of objects and a new engine speed of the tow vehicle engine during the subsequent time window. Therefore, the controller 160 can continuously refine a total efficiency representation specific to each tow vehicle-trailer combination, such that the controller 160 can calculate a target motor torque output at newly-encountered operating conditions on demand.

### 6.4.1 Total Efficiency Representation

In one variation, Block S128 of the method S100 recites transforming the set of objects into a total efficiency representation (e.g., a three-dimensional virtual surface, a plot, a graphic representation, a matrix) correlating motor torque outputs at the trailer motor 130, engine speeds of the tow vehicle engine, and efficiency metrics of the tow vehicle and the trailer 110. For example, the total efficiency representation can include: a set of points, each point in the set of points corresponding to an object in the set of objects; and a surface approximating a convex region enclosing the set of points, such as a convex hull (e.g., a best-fit surface) fitted to the data points and defining a continuous surface enabling interpolation between measured operating conditions.

In one example, the controller can generate a three-dimensional virtual surface interpolated between combinations of motor torque output at the trailer motor, engine speed of the tow vehicle engine, and efficiency metrics of the tow vehicle and the trailer represented by each object in the set of objects.

In this example, the controller 160 plots each data point in three-dimensional space with axes representing: (1) engine speed (e.g., between 1500 and 2500 RPM), (2) trailer motor torque output (e.g., between 50 and 200 Nm), and (3) measured system efficiency (e.g., between 25 and 35 kWh per mile; between 28% and 38% efficiency). The controller 160 then fits a continuous three-dimensional virtual surface to these points, such as by constructing a convex hull that encloses all data points, to create a smooth, interpolatable representation of tow vehicle-trailer performance across the tested operating conditions. The controller 160 can then estimate a target trailer torque at a new engine speed (e.g., a non-tested speed) by interpolating between neighboring measured data points along the three-dimensional virtual surface.

Additionally, the controller 160 can continuously refine the three-dimensional virtual surface by plotting newly-measured data points captured during operation (e.g., during perturbation testing along the drive route) and re-fit the convex hull or update local interpolation weights to reflect the current set of points. In particular, by capturing and plotting these newly-measured data points, the controller 160 can continuously adapt the total efficiency representation to gradual changes in vehicle performance over time, such as engine wear, tire replacement, or temperature variations, while maintaining historical context.

### 6.4.2 Total Efficiency Function

In one variation, Block S128 of the method S100 recites deriving a total efficiency function representing a mathematical relationship between motor torque outputs at the trailer motor 130, engine speeds of the tow vehicle engine, and efficiency metrics of the tow vehicle and the trailer 110 based on the set of objects. For example, the controller 160 can implement regression analysis, polynomial curve fitting, or a neural network to transform the set of objects into a mathematical function, such as a mathematical function including coefficients configured to minimize prediction error across the dataset.

Additionally, the controller 160 can continuously recalibrate the function coefficients as based on newly-measured data points captured during operation (e.g., during perturbation testing along the drive route). For example, the controller 160 can implement methods and techniques described above to: perturb trailer motor torque output during a subsequent time window; and estimate an efficiency metric of the tow vehicle and the trailer 110 during the subsequent time window based on a distance traveled by the tow vehicle, a net energy consumption from the battery, and a fuel consumption of the tow vehicle engine during the subsequent time window. The controller 160 can then calibrate the total efficiency function based on the trailer motor torque output at the trailer motor 130, the efficiency metric of the tow vehicle and the trailer 110, and the tow vehicle engine speed of the tow vehicle engine during the subsequent time window by comparing predicted efficiency from the function against measured efficiency, calculating residual error, and adjusting function coefficients to reduce prediction error. In particular, the controller 160 can re-calibrate the total efficiency function based on a difference between a target efficiency metric (i.e., estimated for the particular time window) and a real efficiency metric of the tow vehicle and the trailer 110.

### 6.4.3 Controls: Torque Output Modulation

Blocks of the method S100 recite: estimating a first efficiency metric of the tow vehicle and the trailer 110 during a first time window in Block S160; accessing a first engine speed of the tow vehicle engine during the first time window in Block S112; accessing a total efficiency representation defining correlations between motor torque outputs at the trailer motor 130, engine speeds of the tow vehicle engine, and efficiency metrics of the tow vehicle and the trailer 110 in Block S162; identifying a first peak efficiency at the first engine speed based on the total efficiency representation in Block S166; and calculating a second motor torque output for the trailer motor 130 during a second time window based on the total efficiency representation in Block S152, the second motor torque output different from the first motor torque output and predicted to reduce the first difference between the first efficiency metric and the first peak efficiency at the first engine speed.

Generally, the controller 160 can: query the total efficiency representation for a target trailer torque at a current engine speed in Block S162; compare measured efficiency against predicted peak efficiency for current operating conditions in Block S166; and incrementally modulate trailer torque toward the target motor torque output to close the efficiency gap in Block S152.

In one implementation, the controller 160 can implement methods and techniques described above to: set a first motor torque output (e.g., 100 Nm) at the trailer motor 130 during a first time window; estimate a first efficiency metric (e.g., 31.2 kWh per mile, or 30%) of the tow vehicle and the trailer 110 during the first time window; and access a first engine speed (e.g., 1,800 RPM) of the tow vehicle engine during the first time window. The controller 160 can then: identify a first peak efficiency (e.g., 29.5 kWh per mile, or 35%) at the first engine speed based on the total efficiency representation; and detect a first difference between the first efficiency metric and the first peak efficiency. The controller 160 can then calculate a second motor torque output (e.g., 125 Nm) for the trailer motor 130 during a second time window based on the total efficiency representation, the second motor torque output: different from the first motor torque output; and predicted to reduce the first difference between the first efficiency metric and the first peak efficiency at the first engine speed.

In one example, the controller 160 can: identify a target motor torque output at the first engine speed based on the total efficiency representation; and, in response to the first motor torque output falling below the target motor torque output, calculate the second motor torque output greater than the first motor torque output by less than a threshold difference (e.g., 20 Nm, 30 Nm, 50 Nm), such that the controller 160 incrementally approaches the target motor torque output (i.e., rather than triggering a relatively-large torque increase at the trailer motor 130) to verify efficiency at a series of intermediate motor torque outputs and prevent abrupt torque changes that may disrupt vehicle stability or driver comfort.

In another example in which the total efficiency representation includes a three-dimensional virtual surface, the controller 160 can: project the three-dimensional virtual surface into a two-dimensional virtual curve relating motor torque outputs and efficiency metrics at the engine speed of the tow vehicle engine; and set the target motor torque output based on a peak efficiency metric represented in the two-dimensional virtual curve. For example, the controller 160 can estimate the target motor torque output at the current engine speed based on a weighted average of nearby data points on the surface (e.g., with a weight of each data point inversely proportional to distance from the query point in engine speed-torque space).

In another example, the controller 160 can: implement methods and techniques described above to derive a total efficiency function that represents a mathematical relationship between motor torque outputs at the trailer motor 130, engine speeds of the tow vehicle engine, and efficiency metrics of the tow vehicle and the trailer 110; and calculate the second motor torque output based on the first engine speed and the total efficiency function. Therefore, the controller 160 can predict the target motor torque output at any engine speed on demand based on the total efficiency representation and/or a function defining relationships between motor torque outputs at the trailer motor 130, engine speeds of the tow vehicle engine, and efficiency metrics of the tow vehicle and the trailer 110.

### 6.4.4 Torque Output Range+Estimation Confidence

In one variation, the controller 160 can: access an engine speed at the tow vehicle engine; calculate a confidence score for target torque prediction at the tow vehicle engine speed based on a subset of objects, in the set of objects, including engine speeds within a threshold difference from the tow vehicle engine speed; in response to the confidence score falling below a threshold confidence score, calculate a torque range (e.g., rather than an individual motor torque output) for the trailer motor 130 based on the set of objects; select a first motor torque output from the torque range; and set the first motor torque output at the trailer motor 130 during a first time window. The controller 160 can then implement methods and techniques described above to: estimate a first efficiency metric of the tow vehicle-trailer during the first time window; set a second motor torque output at the trailer motor 130 during a second time window, the second motor torque output within the torque range and different from the first motor torque output; and estimate a second efficiency metric of the tow vehicle-trailer during the second time window.

The controller 160 can then repeat this process to iteratively test different torque values within the torque range and store new objects, representing corresponding efficiency data at these different torque values, in the set of objects, such as to increase future estimation confidence at this engine speed. Thus, in this variation, in response to detecting insufficient historical data density at a particular engine speed, rather than calculating an individual motor torque output, the controller 160 can calculate a torque range predicted to yield total efficiency metrics of the tow vehicle and the trailer 110 within a target efficiency metric range at the tow vehicle engine speed.

In one example, the controller 160 can: access the total efficiency representation including a set of points, each point in the set of points corresponding to a motor torque output at the trailer motor 130, an engine speed of the tow vehicle engine, and an efficiency metric of the tow vehicle and the trailer 110; access an engine speed of 2,100 RPM at the tow vehicle engine; identify a subset of points, in the set of points, corresponding to engine speeds within a threshold difference from the tow vehicle engine speed of 2,100 RPM; and calculate a confidence score of 35% for target torque prediction at the tow vehicle engine speed of 2,100 RPM based on based on a density of points in the subset of points. In particular, in this example, the controller 160 calculates the confidence score based on a density (e.g., a quantity and spatial distribution) of measured data points proximal the engine speed (e.g., within ±100 RPM), wherein a relatively-high point density (e.g., greater than ten points within ±100 RPM) indicates well-characterized operating conditions and corresponds to relatively-high estimation confidence.

In response to the confidence score falling below a threshold confidence score (e.g., 60%), the controller 160 can then calculate a torque range between 110 Nm and 140 Nm for the trailer motor 130 based on motor torque outputs and efficiency metrics of the subset of points, the torque range predicted to yield total efficiency metrics of the tow vehicle and the trailer 110 within a target efficiency metric range (e.g., between 32% and 36%) for the tow vehicle engine speed of 2,100 RPM. The controller 160 can then select a first motor torque output of 125 Nm from the torque range; and set the first motor torque output at the trailer motor 130 during a first time window.

The controller 160 can then implement methods and techniques described above to: estimate a first efficiency metric of 33% for the tow vehicle-trailer during the first time window; set a second motor torque output of 130 Nm at the trailer motor 130 during a second time window succeeding the first time window; and estimate a second efficiency metric of 31% for the tow vehicle-trailer during the second time window. In this example, in response to the second efficiency metric falling below the first efficiency metric, the controller 160 can set a third motor torque output (e.g., 120 Nm) at the trailer motor 130, the third motor torque output within the torque range and different from the second motor torque output. Therefore, the controller 160 can calculate a torque range for the trailer motor 130 when encountering an under-characterized engine speed and thus, increase total efficiency of the tow vehicle-trailer toward the peak efficiency while simultaneously refining efficiency estimates for future torque output estimations at similar operating conditions.

### 6.4.5 Gear Shift Prompting

In one variation, Blocks of the method S100 recite: estimating a first efficiency metric of the tow vehicle and the trailer 110 during a first time window while the trailer motor 130 outputs a first motor torque output in Block S160; identifying a first peak efficiency at a first engine speed of the tow vehicle engine during the first time window based on the total efficiency representation in Block S160; in response to a first difference between the efficiency metric and the first peak efficiency exceeding a threshold, calculating a second engine speed, less than the first engine speed, for the tow vehicle engine and a second motor torque output, greater than the first motor torque output, for the trailer motor 130 based on the total efficiency representation in Block S140; accessing a first gear position of a transmission subsystem of the tow vehicle during the first time window in Block S110; interpreting a second gear position, predicted to yield the second engine speed at the velocity, for the transmission subsystem during the first time window in Block S142; prompting the tow vehicle to upwardly shift the transmission subsystem to the second gear position during the second time window in Block S144; and triggering the trailer motor 130 to increase torque output toward the second motor torque output in Block S150.

In this variation, the controller 160 can further interface with the tow vehicle to prompt the operator to shift the gear to a target gear position. In one example, the controller 160 can interface with a display accessible by an operator (e.g., driver) of the tow vehicle-trailer. In particular, in this variation, the controller 160 can implement methods and techniques described above to detect a difference between an efficiency metric, estimated for the tow vehicle-trailer during a particular time window, and a peak efficiency identified for an engine speed of the tow vehicle engine during the time window. The controller 160 can then selectively adjust trailer torque or coordinate an increase in trailer torque with tow vehicle gear change based on the difference between the efficiency metric and the peak efficiency. More specifically, the controller 160 can compare the difference to a minimum threshold (e.g., 0.5 kWh per mile) that represents a relatively-small efficiency gap (e.g., addressable via motor torque output modulation) and a maximum threshold (e.g., 2.0 kWh per mile) that represents a relatively-large efficiency gap (e.g., requiring motor torque output modulation and engine speed adjustment via gear shift). The controller 160 can then selectively: increase trailer motor torque output to reach peak efficiency through trailer assistance (i.e., without a gear change); or prompt the tow vehicle to shift gears in addition to increasing motor torque output.

In one example, the controller 160 can selectively modulate motor torque output and prompt a tow vehicle gear shift when the trailer motor 130 outputs torque assistance to the tow vehicle engine while the tow vehicle-trailer traverses an incline (e.g., a hill). In this example, the controller 160 can implement methods and techniques described above to: set a first motor torque output (e.g., 80 Nm) at the trailer motor 130 during a first time window; estimate a first efficiency metric (e.g., 33.5 kWh per mile) of the tow vehicle and the trailer 110 during the first time window; identify a first peak efficiency (e.g., 32.8 kWh per mile) at the first engine speed based on the total efficiency representation; and detect a first difference between the first efficiency metric and the first peak efficiency. In response to the first difference (e.g., 0.7 kWh per mile) between the first efficiency metric and the first peak efficiency exceeding a minimum threshold (e.g., 0.5 kWh per mile) and falling below a maximum threshold (e.g., 2.0 kWh per mile), the controller 160 can: calculate a second motor torque output of 110 Nm for the trailer motor 130, the second motor torque output predicted to reduce the first difference between the first efficiency metric and the first peak efficiency of the tow vehicle engine at the first engine speed; and set the second motor torque output at the trailer motor 130 during a second time window succeeding the first time window. In particular, in response to the first difference exceeding the minimum threshold and falling below the maximum threshold, the controller 160 can interpret that the tow vehicle engine is currently operating below peak efficiency for the current engine speed, and that increasing trailer torque can shift system load distribution to bring total efficiency closer to the peak efficiency without requiring intervention at the tow vehicle (i.e., a gear change).

Alternatively, in response to the first difference (e.g., 2.5 kWh per mile) exceeding the maximum threshold (e.g., 2.0 kWh per mile), the controller 160 can calculate a second engine speed (e.g., 2,200 RPM), less than the first engine speed (e.g., 1,600 RPM), and a second motor torque output (e.g., 150 Nm), greater than the first motor torque output, based on the total efficiency representation. In particular, the controller 160 can calculate a second engine speed and a second motor torque output predicted to reduce the first difference between the first efficiency metric and the first peak efficiency at the second engine speed.

The controller 160 can then: access a first gear position of the transmission subsystem of the tow vehicle during the first time window; interpret a second gear position, for the transmission subsystem based on the second engine speed; prompt the tow vehicle to upwardly shift the transmission subsystem to the second gear position; and trigger the trailer motor 130 to increase torque output toward the second motor torque output. In particular, in response to the second difference exceeding the maximum threshold, the controller 160 can interpret that the engine operates significantly below peak efficiency at the current engine speed and coordinate intervention to increase engine speed via a gear shift while simultaneously increasing trailer assistance to maintain vehicle velocity during the gear transition. Therefore, in this variation, the controller 160 can selectively modulate motor torque output and prompt tow vehicle gear shifting based on a magnitude of an efficiency gap (e.g., between current and peak efficiency).

### 6.4.6 Maximum Torque Assistance Verification

In one variation, Blocks of the method S100 recite: estimating a total weight of the tow vehicle and the trailer 110 in Block S136; estimating a total torque required to maintain a velocity (e.g., a current velocity of the tow vehicle-trailer) based on the velocity, an incline angle of the trailer 110, the total weight, and a cross-sectional area of the tow vehicle in Block S156; estimating a first engine torque output by the tow vehicle engine during a first time window based on a difference between the total torque required to maintain the velocity and a first motor torque output by the trailer motor 130 during the first time window in Block S158; estimating a second engine torque output by the tow vehicle engine following upshift to a target gear position during a second time window in Block S158; and calculating a second motor torque output (e.g., required motor torque output) for the trailer motor 130 during the second time window based on a difference between the total torque required to maintain the velocity and the second engine torque output in Block S152.

In this variation, prior to prompting the tow vehicle to upwardly shift the gear position of the transmission subsystem of the tow vehicle, the controller 160 can: estimate a total torque required to maintain a velocity (e.g., a current velocity of the tow vehicle-trailer) during a next time window; estimate an engine torque contribution to the total torque at the new target engine speed and new target gear position during the next time window; estimate a motor torque contribution to the total torque during the next time window; and verify that the estimated motor torque contribution falls below a maximum torque capacity of the trailer motor 130.

In particular, in this variation, the controller 160 can implement methods and techniques described above to: identify a target second engine speed and corresponding second gear position from total efficiency representation; and calculate a second motor torque output required to maintain current velocity following gear change. The controller 160 can then: detect an incline (or decline) angle of the trailer 110 during a first time window; access a velocity of the tow vehicle during the first time window; estimate a total weight of the tow vehicle and the trailer 110; access a cross-sectional area of the tow vehicle; and estimate a total torque required to maintain a velocity (e.g., a current velocity of the tow vehicle-trailer) based on the velocity, the incline (or decline) angle of the trailer 110, the total weight of the tow vehicle-trailer, and the cross-sectional area of the tow vehicle.

For example, the controller 160 can estimate the weight of the tow vehicle-trailer, such as by: triggering the trailer motor 130 to output a calibration torque while the trailer 110 travels at a constant speed on flat ground; detecting an acceleration responsive to output of the calibration torque; interpreting the acceleration as a longitudinal force applied to the trailer 110; calculating the effective tractive force generated by the calibration torque at the driven axle 120 (e.g., by dividing torque by wheel radius); and calculating the weight as a function of the ratio between the tractive force and the measured acceleration. In particular, the controller 160 can calculate: gravitational resistance as a function of weight and incline angle; rolling resistance as a function of weight and velocity; aerodynamic drag as a function of velocity and the cross-sectional area; and acceleration demand. The controller 160 can then sum these forces and convert the combined force into the total torque based on a wheel radius of wheels of the trailer 110.

The controller 160 can then: estimate a first engine torque output by the tow vehicle engine during the first time window based on a difference between the total torque required to maintain the velocity and a first motor torque output by the trailer motor 130 during the first time window; estimate a second engine torque output by the tow vehicle engine following upshift to the second gear position based on the first engine torque output, a first gear ratio corresponding to the first gear position, and a second gear ratio corresponding to the second gear position; and calculate a second motor torque output for the trailer motor 130 based on a difference between the total torque required to maintain the velocity and the second engine torque output by the tow vehicle engine during the second time window. The controller 160 can then: access a maximum torque capacity of the trailer motor 130 (e.g., 1,600 Nm); and, in response to the second motor torque output falling below the maximum torque capacity of the trailer motor 130, prompt the tow vehicle to upwardly shift the transmission subsystem to the second gear position. Accordingly, the controller 160 can verify trailer motor 130 can output the required torque prior to prompting the tow vehicle to initiate a gear shift to prevent operating conditions that may result in the tow vehicle decelerating or stalling.

### 6.5 Variation: Total Tow Vehicle-Trailer Efficiency+Engine Efficiency

In one variation, Blocks of the method S100 recite: accessing a first signal output by the external communication adapter 150 connected to a data port of the tow vehicle and representing a first engine speed of the tow vehicle engine during the first time window in Block S110; calculating a first motor torque output for the trailer motor 130 based on motor torque outputs and efficiency metrics of objects in the set of objects including engine speeds within a threshold difference from the first engine speed in Block S152; in response to absence of a second signal representing a second engine speed of the tow vehicle engine during a second time window, interpreting loss of communication with the external communication adapter 150 in Block S172; in response to interpreting loss of communication with the external communication adapter 150, estimating a second total torque required to maintain the second velocity and a second engine torque output by the tow vehicle engine during the second time window in Block S156; and calculating a second motor torque output for the trailer motor 130 based on motor torque outputs and efficiency metrics of objects in the set of objects including engine torque outputs within the threshold difference from the second engine torque output in Block S152. In this variation, the controller 160 can store engine torque estimates as an additional dimension in the total efficiency representation, such as to maintain torque output modulation capability during communication failures with the external communication adapter 150 (e.g., when directly-measured engine speed is unavailable).

In particular, in this variation, the controller 160 can implement methods and techniques described above to: estimate a total torque required to maintain a current velocity; estimate an engine torque output by the tow vehicle engine during a time window based on the total torque and a motor torque output by the trailer motor 130 during the time window; estimate an efficiency metric of the tow vehicle and the trailer 110 during a time window; and access an engine speed of the tow vehicle engine during the time window. The controller 160 can then generate an object that includes: the trailer motor torque output at the trailer motor 130 during the time window; the efficiency metric of the tow vehicle and the trailer 110 during the time window; the tow vehicle engine speed of the tow vehicle engine during the time window; and the tow vehicle engine torque output by the tow vehicle engine during the time window. The controller 160 can then selectively calculate motor torque outputs based on availability of engine speed data and/or engine torque data, thereby maintaining torque output modulation capability during communication disruptions without requiring operator intervention.

In one example, the controller 160 can: access a first engine speed of the tow vehicle engine wirelessly broadcast by the external communication adapter 150; identify a first subset of objects, in the set of objects, including engine speeds within a threshold difference from the first engine speed; calculate a second motor torque output for the trailer motor 130 based on motor torque outputs and efficiency metrics of objects in the first subset of objects; and set the second motor torque output at the trailer motor 130 during a second time window.

In response to absence of a second signal representing a second engine speed of the tow vehicle engine during the second time window, the controller 160 can then interpret loss of communication with the external communication adapter 150. In response to interpreting loss of communication with the external communication adapter 150, the controller 160 can estimate a second total torque required to maintain the second velocity based on: a second incline angle of the trailer 110 during the second time window; the second velocity of the tow vehicle during the second time window; a total weight of the tow vehicle-trailer; and the cross-sectional area of the tow vehicle. The controller 160 can further: estimate a second engine torque output by the tow vehicle engine during the second time window based on a second difference between: the second total torque required to maintain the second velocity; and the second motor torque output by the trailer motor 130 during the second time window. The controller 160 can then: identify a second subset of objects, in the set of objects, including engine torque outputs within the threshold difference from the second engine torque output; calculate a third motor torque output for the trailer motor 130 based on motor torque outputs and efficiency metrics of objects in the second subset of objects; and set the third motor torque output at the trailer motor 130 during a third time window. Thus, in this example, the controller 160 can detect communication loss, automatically estimate current engine torque from measurable tow vehicle-trailer operating conditions, and query historical efficiency data at similar engine torque points for a target motor torque output.

### 7. Torque Output Modulation Based on Driver Intent

In one variation, Blocks of the method S100 recite: accessing a velocity of the tow vehicle during a time window in Block S110; and interpreting an intent at the tow vehicle to maintain the velocity in Block S190. In this variation, the controller 160 can: monitor operational data of the tow vehicle-trailer to detect steady-state driving conditions; verify intent at the tow vehicle to maintain constant speed, such as by confirming velocity and engine speed stability over sustained duration; and selectively execute perturbation testing during steady-state operating conditions (e.g., constant velocity) to prevent test execution during transient acceleration or braking events that may skew or invalidate measurements.

In particular, in this variation, the controller 160 can: access a velocity of the tow vehicle during a time window; and, in response to the velocity falling within a threshold velocity range (e.g., ±2 miles per hour, between 63-67 mph) during the time window and in response to detecting the tow vehicle engine speed within a threshold engine speed range (e.g., ±50 RPM, between 1,750-1,850 RPM) during the time window and in response to the time window exceeding a threshold duration (e.g., 20 seconds), interpret an intent at the tow vehicle to maintain the velocity. In response to interpreting intent at the tow vehicle to maintain the current velocity, the controller 160 can then implement methods and techniques described above to: perturb motor torque output by the trailer motor 130 during the next time window; estimate a new efficiency metric for the tow vehicle-trailer during the next time window; and store a new object, including these data, in the set of objects. Thus, the controller 160 can verify intent at the tow vehicle to maintain steady-state conditions prior to initiating perturbation testing, such that the controller 160 can accurately characterize torque effects on system efficiency.

### 7.1 Tow Vehicle Intent Based on Observed Operational Data

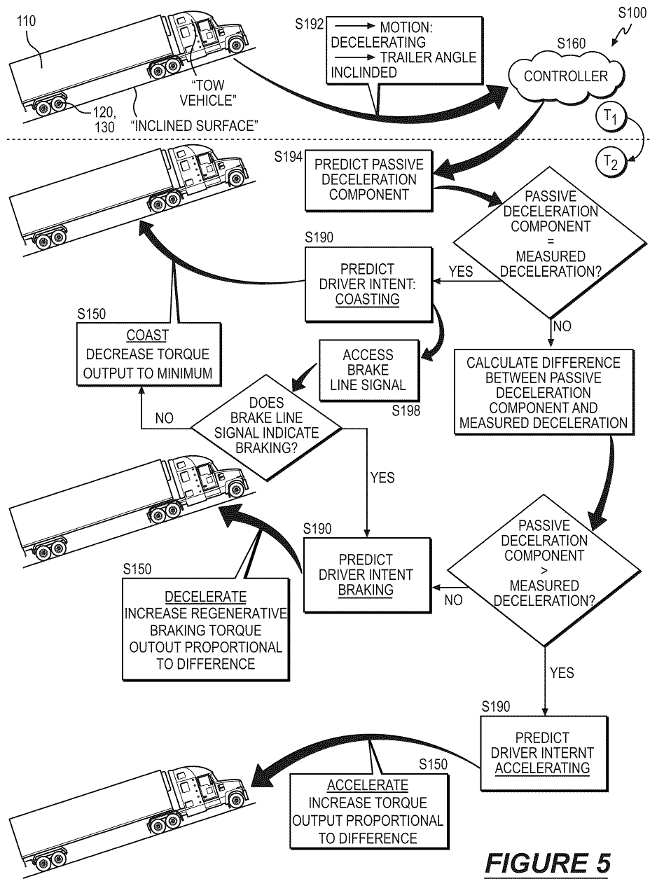

In one variation, as shown in FIG. 5, Blocks of the method S100 recite: detecting a deceleration and an incline angle of the trailer 110 during a time window in Block S192; estimating a passive deceleration component of the deceleration based on the incline angle in Block S194; in response to the passive deceleration component exceeding the deceleration, interpreting an intent at the tow vehicle to accelerate in Block S190; and increasing motor torque output of the trailer motor 130 proportional to a difference between the passive deceleration component and the deceleration in Block S150.

In this variation, the controller 160 can: distinguish driver acceleration intent from steady-state operation by comparing measured vehicle deceleration against terrain-predicted passive deceleration; and immediately suppress perturbation testing while proportionally increasing trailer torque to support an acceleration demand at the tow vehicle. In particular, in this variation, the controller 160 can execute Blocks of the method S100 to: detect an incline angle (e.g., via a tilt sensor) and direction of motion of the trailer 110 representing motion of the trailer 110 along a positive sloped surface (e.g., uphill); detect a deceleration of the trailer 110 (e.g., via an accelerometer) representing a decrease in velocity during uphill travel; and interpret a residual deceleration component indicating active braking or increased rolling resistance. More specifically, the passive deceleration component can be attributed to one or more contributing forces acting opposite the direction of motion, including: gravitational resistance from uphill slope; rolling resistance between tires and surface; mechanical drag from drivetrain components; and/or or aerodynamic drag. Accordingly, the controller 160 can calculate a difference representing a residual component of deceleration that suggests that the driver of the tow vehicle is actively braking. Based on this difference, the controller 160 can selectively modulate torque output of the trailer motor 130.

In another variation, in response to the deceleration exceeding the passive deceleration component, the controller 160 can interpret an intent at the tow vehicle to decelerate (i.e., brake). In particular, the controller 160 can increase regenerative braking of the trailer motor 130 proportional to the difference between the passive deceleration component and the deceleration. Therefore, the controller 160 can: detect a difference between the passive deceleration component and the actual deceleration of the trailer 110; automatically identify whether the trailer 110 is actively accelerating, coasting, or decelerating beyond gravitational contribution; interpret the intent at the tow vehicle from this difference; and selectively increase or reduce torque output (or regenerative braking output) of the trailer motor 130 to support the inferred intent during uphill travel. Alternatively, in response to the deceleration approximating the passive deceleration component, the controller 160 can: interpret an intent at the tow vehicle to coast; and disable torque output assist, such that the trailer 110 rolls passively down the slope without active propulsion or braking. In particular, the controller 160 can decrease torque output of the trailer motor 130 toward null torque output and null braking torque output.

Alternatively, the controller 160 can: detect a decline angle and direction of motion of the trailer 110 representing motion of the trailer 110 along a negative sloped surface (e.g., downhill); detect an acceleration of the trailer 110 representing an increase in velocity during downhill travel; and interpret a residual acceleration, not attributable to slope-induced effects, as an indication of propulsion or external force (e.g., motor output or trailer push from the tow vehicle). In particular, in response to the acceleration exceeding the passive acceleration component, the controller 160 can: interpret an intent at the tow vehicle to accelerate (e.g., apply torque output downhill); and increase torque output of the trailer motor 130 proportional to the difference. For example, the controller 160 can: calculate a longitudinal force predicted to yield the observed difference based on an estimated weight of the trailer 110; calculate a target torque output based on the longitudinal force and the wheel radius; and increase trailer motor torque output according to the target torque.

In another variation, in response to the acceleration falling below the passive acceleration component, the controller 160 can: interpret an intent at the tow vehicle to brake; and increase regenerative braking of the trailer motor 130 proportional to the difference between the passive acceleration component and the actual acceleration. Alternatively, in response to the acceleration approximating the passive acceleration component, the controller 160 can: interpret an intent at the tow vehicle to coast; and decrease torque output of the trailer motor 130 toward null torque output and null braking torque output (e.g., idle or zero-torque mode), such that the trailer 110 descends without active propulsion or braking. Therefore, the controller 160 can: interpret residual deceleration (or acceleration) components, unaccounted for by terrain-predicted passive forces, as definitive indicators of driver throttle or brake application; immediately suspend efficiency perturbation testing to prevent corrupted measurements; and dynamically adjust trailer motor output to align with inferred driver intent, such as to provide seamless propulsion assistance during acceleration, regenerative braking support during deceleration, or passive coasting when the driver maintains natural vehicle motion.

### 7.2 Tow Vehicle Intent Based on Brake Line Signal

In one variation, as shown in FIG. 5, Blocks of the method S100 recite: detecting a deceleration and incline angle of the trailer 110 during a time window in Block S192; estimating a passive deceleration component of the deceleration based on the incline angle; accessing a signal output by the pressure sensor and representing a change in brake line pressure in the brake line of the trailer 110 during the time window in Block S198; in response to the deceleration exceeding the passive deceleration component and in response to detecting the change in brake line pressure, interpreting an intent at the tow vehicle to decelerate in Block S190; and increasing regenerative braking of the trailer motor 130 proportional to the change in brake line pressure in Block S150.

In this variation, the controller 160 can access signals representing braking activity on the trailer 110 to verify intent at the tow vehicle prior to applying torque control. In particular, the controller 160 can interpret a signal from a pressure sensor coupled to a brake line of the trailer 110 as indicative of a braking command issued by the driver of the tow vehicle. In this variation, the controller 160 can: implement methods and techniques described above to interpret an intent at the tow vehicle to decelerate (i.e., brake); access the signal from the pressure sensor; and verify the intent at the tow vehicle to decelerate the trailer 110 based on the pressure detected within the brake line. More specifically, the controller 160 can interpret a change in pressure within the brake line—as detected by the pressure sensor—as evidence of braking input from the driver.

In one example, the controller 160 can: implement methods and techniques described above to interpret an intent at the tow vehicle to decelerate; detect a change in brake line pressure in the brake line of the trailer 110; and, in response to interpreting the intent at the tow vehicle to decelerate and in response to detecting the change in brake line pressure, increase regenerative braking of the trailer motor 130 proportional to the change in brake line pressure.

In another example, the controller 160 can: access a signal output by the pressure sensor during a time window; detect absence of a change in brake line pressure in the brake line of the trailer 110 based on the signal; implement methods and techniques described above to predict intent at the tow vehicle to maintain the current velocity; and, in response to predicting intent at the tow vehicle to maintain the current velocity speed and in response to absence of the change in brake line pressure, interpret the intent at the tow vehicle to maintain the velocity during the time window. The controller 160 can then implement methods and techniques described above to execute small motor torque perturbations (e.g., ±10 Nm), measure resulting efficiency changes, and store these data in the set of objects.

In another example, the controller 160 can: implement methods and techniques described above to interpret an intent at the tow vehicle to decelerate; detect a change in brake line pressure in the brake line of the trailer 110; and, in response to interpreting the intent at the tow vehicle to decelerate and in response to detecting the change in brake line pressure, increase regenerative braking of the trailer motor 130 proportional to the change in brake line pressure. The controller 160 can then implement methods and techniques described above to: continue monitoring the signal from the brake line and continue interpreting the intent at the tow vehicle; and, in response to verifying alignment between the brake line pressure and the intent at the tow vehicle, modulate torque output of the trailer motor 130 in accordance with the intent at the tow vehicle. Thus, in this variation, the controller 160 can validate a predicted intent at the tow vehicle and apply or withhold torque output accordingly.

### 8. Regenerative Torque Output Mode

In one variation, Blocks S132 and S142 of the method S100 recite: triggering the trailer motor 130 to disable torque output in the first direction of motion; and calculating a target gear and a target regenerative braking torque output, opposite the first direction of motion, to reduce the first difference between the first efficiency and the maximum efficiency of the tow vehicle engine at the first engine speed. In particular, in Blocks S132 and S142, the controller 160 can: disable the torque output assist mode; and calculate a regenerative torque output and a gear selection in order to achieve the maximum engine efficiency.

In this variation, the controller 160: detects a charge state of the battery assembly 140 and a geospatial location of the trailer 110; and retrieves a drive route for the trailer 110 defining a start location, a target location, a set of weight parameters and/or a target battery capacity associated with the drive route entered by a user from a user portal. The controller 160 then maintains the torque output by the trailer motor 130 to the driven axle 120 or enters a regenerative torque output mode (e.g., regenerative braking mode) based on the charge state of the battery, the geospatial location of the trailer 110, and the drive route.

In one variation, the controller 160: detects a charge state of the battery assembly 140 and a geospatial location of the trailer 110; retrieves a drive route for the trailer 110 defining a target battery capacity from a drive route for the trailer 110, a start location, and a target location; and calculates a remaining distance of the drive route between the geospatial location of the trailer 110 and the target location. Then, in response to the charge state of the battery assembly 140 falling below the target battery capacity, the controller 160: disables torque output by the trailer motor 130 in the direction of motion of the trailer 110; calculates a target regenerative braking torque output, opposite the direction of motion, to maintain the maximum efficiency of the tow vehicle engine at the baseline ground speed of the tow vehicle-trailer and to recharge the battery assembly 140; and triggers the trailer motor 130 to increase regenerative braking torque output to the target regenerative braking torque output to recharge the battery assembly 140 and to enable the tow vehicle-trailer to complete the remaining distance of the drive route.

Additionally, the controller 160 can calculate a target gear position and a target regenerative braking torque output to maintain the maximum engine efficiency and prompt an operator (e.g., a driver) to shift gears to the target gear position via a graphical display accessible by the operator in Block S144. In one example, responsive to the charge state of the battery assembly 140 falling below the target battery capacity, the controller 160 can: calculate a gear position and a target regenerative braking torque output to maintain the maximum engine efficiency; generate a prompt indicating the target gear position at the baseline ground speed; serve the prompt to the graphical display; and trigger the trailer motor 130 to increase regenerative braking torque output to the target regenerative braking torque output to recharge the battery assembly 140 in Block S150. Therefore, the controller 160 can maintain the maximum efficiency of the tow vehicle engine by triggering the trailer motor 130 to incrementally increase or decrease the regenerative braking torque output to recharge the battery assembly 140 and by prompting the operator to downshift or upshift gears to a target gear position.

### 8.1 Battery Management+Total Tow Vehicle-Trailer Efficiency

In one variation, Blocks of the method S100 recite: accessing a first engine speed of the tow vehicle engine during a first time window in Block S110; accessing a first charge state of the battery during the first time window in Block S114; calculating a second engine speed, greater than the first engine speed, for the tow vehicle engine and a second regenerative braking torque output for the trailer motor 130 during a second time window in Block S140; accessing a first gear position of a transmission subsystem of the tow vehicle during the first time window in Block S110; interpreting a second gear position, predicted to yield the second engine speed at the velocity, for the transmission subsystem during the second time window in Block S142; prompting the tow vehicle to downwardly shift the transmission subsystem to the second gear position during the second time window in Block S144; and triggering the trailer motor 130 to increase torque output toward the second motor torque output in Block S150. In this variation, the controller 160 can: suppress motor torque output assist when the battery charge state falls below a threshold (e.g., to preserve emergency reserve capacity); and/or coordinate a tow vehicle gear shift with trailer regenerative braking to recharge the battery while maintaining vehicle velocity.

In one example, the controller 160 can: access a charge state of the battery during a first time window; and, in response to the charge state of the battery exceeding a maximum threshold charge state (e.g., 90%), set a new motor torque output, greater than a current motor torque output, at the trailer motor 130 during the next time window. Alternatively, in this example, in response to the charge state of the battery falling below a minimum threshold charge state (e.g., 10%), the controller 160 can: implement methods and techniques described above to: estimate an efficiency metric of the tow vehicle and the trailer 110 during the first time window; access a first engine speed of the tow vehicle engine during the first time window; identify a first peak efficiency at the first engine speed (e.g., based on the total efficiency representation); and calculate a difference between the first efficiency metric and the first peak efficiency.

The controller 160 can then calculate a second engine speed, greater than the first engine speed, for the tow vehicle engine and a regenerative braking torque output for the trailer motor 130 during the next time window based on the total efficiency representation. In particular, the controller 160 can calculate the second engine speed and the regenerative braking torque output predicted to yield a second peak efficiency at the second engine speed (i.e., while charging the battery). The controller 160 can then implement methods and techniques described above to: interpret a target gear position for the transmission subsystem (e.g., less than a current gear position) during the second time window; prompt the tow vehicle to downwardly shift the transmission subsystem to the target gear position during the second time window; and trigger the trailer motor 130 to increase regenerative braking torque output toward the regenerative braking torque output and to recharge the battery during the second time window.

### 9. Absent External Communication Adapter: Historical Efficiency Data

In one implementation, the controller 160: detects absence of operational data from the external communication adapter 150; interfaces with the graphical display to receive selection of a tow vehicle type from the operator (e.g., driver, yard manager); retrieves an historical profile - such as an engine efficiency plot or an engine efficiency model - associated with the tow vehicle type from the tow vehicle engine efficiency database; identifies a maximum efficiency or an acceptable efficiency range for the tow vehicle engine based on the data stored in the historical profile; and executes Blocks of the method S100 to autonomously increase torque output and/or deactivate torque output by the trailer motor 130 to achieve and maintain the maximum engine efficiency.

For example, the external communication adapter 150 may not couple to a diagnostic port of the tow vehicle. Responsive to absence of operational data from the external communication adapter 150, the controller 160 can: interface with the display to receive selection of a diesel tow vehicle type from a driver; retrieve an engine efficiency plot, associated with this diesel tow vehicle type, from the tow vehicle engine efficiency database; identify a set of historical torque outputs associated with the tow vehicle engine efficiency plot; detect a direction of motion and a ground speed of the tow vehicle-trailer via an IMU sensor in the trailer 110; calculate a target torque output predicted to increase the efficiency of the tow vehicle engine to the maximum efficiency based on the ground speed and the set of historical torque outputs; and trigger the trailer motor 130 to increase torque output to the driven axle 120 toward the target torque output in the direction of motion of the trailer 110 to achieve the maximum efficiency of the tow vehicle engine.

Therefore, when the external communication adapter 150 is absent or operational data of the tow vehicle is absent, the controller 160 can: retrieve an engine efficiency plot or model associated with a type of a tow vehicle or a fleet of tow vehicles from the tow vehicle engine efficiency database; and modulate torque output and/or regenerative torque output to achieve and maintain a maximum efficiency defined in the tow vehicle engine efficiency plot or model.

### 10. Data Encryption+Communication

In one implementation, the external communication adapter 150 can establish a connection with a network (e.g., a controller 160 area network bus) associated with the tow vehicle. The external communication adapter 150 can then receive and transfer data from the tow vehicle to the controller 160 via the wireless communication module and vice versa.

In one variation, the external communication adapter 150 can: initiate a one-way communication protocol; receive operational data—such as estimated fuel consumption, an engine speed, a throttle position, a brake position, and/or gear selection—via the diagnostic port; encrypt these operational data; and transfer encrypted operational data to the wireless communication module for decryption by the controller 160 via a wireless communication protocol. Thus, the external communication adapter 150 can: couple to various diagnostic or data ports of any tow vehicle type; and execute a one-way encrypted communication protocol to transfer encrypted operational data of the tow vehicle to the controller 160, thereby providing an additional security measure for these operational data and ensuring confidentiality of these communicated data between the tow vehicle and the trailer 110.

In another variation, the external adapter can: initiate a two-way communication protocol; receive operational data - such as estimated fuel consumption, an engine speed, a throttle position, a brake position, and/or engine torque—via the diagnostic port; encrypt these operational data; transfer the encrypted operational data to the wireless communication module for decryption by the controller 160 via a wireless communication protocol; and transfer encrypted driving conditions data of the trailer 110—such as payload on a driven axle 120 of the trailer 110, a charge state of the battery assembly 140, an angle of the trailer 110 relative to a ground surface, a wind speed proximal the trailer 110, and/or an ambient temperature of air proximal the trailer 110—from the wireless communication module to the diagnostic port of the tow vehicle for decryption. Thus, the external adapter can execute a two-way encrypted communication protocol to transfer encrypted operational data of the tow vehicle to the controller 160 and encrypted driving conditions of the trailer 110 to the diagnostic port of the tow vehicle.

Additionally, the wireless communication module can include a rolling buffer configured to store operational data (e.g., a throttle position, an engine speed, an estimated fuel consumption) for a particular period of time (e.g., thirty minutes, one hour) in local memory. Alternatively, the rolling buffer can: store data in local memory until the data stored reaches a data storage threshold; and discard data in response to expiration of the particular time period or in response to reaching the data storage threshold. Thus, the wireless communication module can include a roller buffer in order to limit access to data stored in local memory within a particular period of time or a window of time to reach the data storage threshold.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a first time period:
setting a first motor torque output at a trailer motor, arranged in a drive system of a trailer pulled by a tow vehicle, for a first time window;
accessing a first net energy consumption from a battery of the trailer during the first time window;
accessing a first fuel consumption of a tow vehicle engine of the tow vehicle during the first time window;
estimating a first distance traveled by the tow vehicle and the trailer during the first time window;
calculating a first total energy consumption of the tow vehicle and the trailer during the first time window based on a first combination of:
the first net energy consumption from the battery; and
the first fuel consumption of the tow vehicle engine; and
calculating a first efficiency metric of the tow vehicle and the trailer during the first time window based on:
the first distance traveled by the tow vehicle and the trailer; and
the first total energy consumption of the tow vehicle and the trailer;
during a second time period succeeding the first time period:
setting a second motor torque output, greater than the first motor torque output, at the trailer motor for a second time window;
accessing a second net energy consumption from the battery during the second time window;
accessing a second fuel consumption of the tow vehicle engine during the second time window;
estimating a second distance traveled by the tow vehicle and the trailer during the second time window;
calculating a second total energy consumption of the tow vehicle and the trailer during the second time window based on a second combination of:
the second net energy consumption from the battery of the trailer; and
the second fuel consumption of the tow vehicle engine; and
calculating a second efficiency metric of the tow vehicle and the trailer during the second time window based on:
the second distance traveled by the tow vehicle and the trailer; and
the second total energy consumption of the tow vehicle and the trailer; and
during a third time period succeeding the second time period:
in response to the second efficiency metric falling below the first efficiency metric, setting a third motor torque output, less than the second motor torque output, at the trailer motor.

2. The method of claim 1:
further comprising:
during the first time period:
accessing a first engine speed of the tow vehicle engine during the first time window; and
generating a first object comprising:
the first motor torque output at the trailer motor;
the first efficiency metric of the tow vehicle and the trailer; and
the first engine speed of the tow vehicle engine;
during the second time period:
accessing a second engine speed of the tow vehicle engine during the second time window; and
generating a second object comprising:
the second motor torque output at the trailer motor;
the second efficiency metric of the tow vehicle and the trailer; and
the second engine speed of the tow vehicle engine; and
during a fourth time period succeeding the third time period:
accessing a set of objects comprising the first object and the second object;
accessing a fourth engine speed of the tow vehicle engine;
based on the set of objects, calculating a fourth motor torque output for the trailer motor for a fourth time window, the fourth motor torque output predicted to yield a fourth peak efficiency of the tow vehicle and the trailer for the fourth engine speed; and
setting the fourth motor torque output at the trailer motor for the fourth time window.

3. The method of claim 2:
further comprising generating a three-dimensional virtual surface:
relating motor torque outputs at the trailer motor, engine speeds of the tow vehicle engine, and efficiency metrics of the tow vehicle and the trailer; and
interpolated between combinations of motor torque output at the trailer motor, engine speed of the tow vehicle engine, and efficiency metrics of the tow vehicle and the trailer represented by each object in the set of objects; and
wherein calculating the fourth motor torque output for the trailer motor for the fourth time window based on the set of objects comprises:
projecting the three-dimensional virtual surface into a two-dimensional virtual curve relating motor torque outputs and efficiency metrics at the fourth engine speed of the tow vehicle engine; and
setting the fourth motor torque output based on a peak efficiency metric represented in the two-dimensional virtual curve.

4. The method of claim 2:
further comprising deriving a total efficiency function representing a mathematical relationship between motor torque outputs at the trailer motor, engine speeds of the tow vehicle engine, and efficiency metrics of the tow vehicle and the trailer based on the set of objects;
wherein calculating the fourth motor torque output for the trailer motor for the fourth time window based on the set of objects comprises:
calculating the fourth motor torque output based on the fourth engine speed and the total efficiency function; and
estimating a fourth target efficiency metric of the tow vehicle and the trailer for the fourth time window based on the fourth motor torque output; and
further comprising:
during the fourth time period:
calculating a fourth real efficiency metric of the tow vehicle and the trailer during the fourth time window based on:
a fourth distance traveled by the tow vehicle and the trailer during the fourth time window;
a fourth net energy consumption from the battery of the trailer during the fourth time window; and
a fourth fuel consumption of the tow vehicle engine during the fourth time window; and
re-calibrating the total efficiency function based on:
a fourth difference between the fourth target efficiency metric and the fourth real efficiency metric.

5. The method of claim 2:
further comprising, during the first time period:
accessing a first incline angle and a first velocity of the trailer during the first time window;
accessing a total weight of the tow vehicle and the trailer;
accessing a cross-sectional area of the tow vehicle;
estimating a first total torque for the tow vehicle and the trailer to maintain the first velocity based on:
the first incline angle;
the first velocity;
the total weight; and
the cross-sectional area; and
estimating a first engine torque output by the tow vehicle engine during the first time window based on a difference between:
the first total torque for the tow vehicle and the trailer to maintain the first velocity; and
the first motor torque output by the trailer motor during the first time window; and
wherein generating the first object during the first time period comprises generating the first object further comprising:
the first engine torque output by the tow vehicle engine during the first time window.

6. The method of claim 2:
wherein accessing the fourth engine speed of the tow vehicle engine during the fourth time period comprises:
accessing the fourth engine speed of the tow vehicle engine fourth, wirelessly broadcast by an external communication adapter connected to a data port of the tow vehicle;
wherein calculating the fourth motor torque output for the trailer motor for the fourth time window based on the set of objects comprises:
identifying a fourth subset of objects, in the set of objects, comprising engine speeds within a threshold difference from the fourth engine speed; and
calculating the fourth motor torque output for the trailer motor based on motor torque outputs and efficiency metrics of objects in the fourth subset of objects; and
further comprising:
during a fifth time period succeeding the fourth time period:
in response to absence of a fifth signal representing a fifth engine speed of the tow vehicle engine during a fifth time window:
interpreting loss of communication with the external communication adapter;
estimating a fifth total torque for the tow vehicle and the trailer to maintain a fifth velocity of the tow vehicle during the fifth time window; and
estimating a fifth engine torque output by the tow vehicle engine during the fifth time window based on a fifth difference between: the fifth total torque for the tow vehicle and the trailer to maintain the fifth velocity; and a fifth motor torque output by the trailer motor during the fifth time window; and
during a sixth time period succeeding the fifth time period:
identifying a sixth subset of objects, in the set of objects, comprising engine torque outputs within the threshold difference from the fifth engine torque output;
calculating a sixth motor torque output for the trailer motor based on motor torque outputs and efficiency metrics of objects in the sixth subset of objects; and
setting the sixth motor torque output at the trailer motor.

7. The method of claim 1, further comprising:
during a fourth time period:
accessing a fourth velocity of the tow vehicle during a fourth time window;
accessing a fourth charge state of the battery during the fourth time window; and
accessing a fourth engine speed of the tow vehicle engine during the fourth time window; and
during a fifth time period succeeding the fourth time period:
in response to the fourth charge state of the battery falling below a minimum threshold charge state:
calculating a fifth engine speed for the tow vehicle engine and a fifth regenerative braking torque output for the trailer motor for a fifth time window, wherein:
the fifth engine speed is greater than the fourth engine speed; and
the fifth engine speed and the fifth regenerative braking torque output are predicted to yield a fifth peak efficiency for the fifth engine speed while charging the battery;
interpreting a gear position for a transmission of the tow vehicle for the fifth time window, the gear position predicted to yield the fifth engine speed;
generating a notification prompting the tow vehicle to maintain the fourth velocity and downwardly shift the transmission to the gear position for the fifth time window;
serving the notification to the tow vehicle; and
triggering the trailer motor to increase regenerative braking torque output toward the fifth regenerative braking torque output and to recharge the battery during the fifth time window.

8. The method of claim 1:
further comprising, during the first time period:
accessing a first engine speed of the tow vehicle engine during the first time window;
accessing a first velocity of the trailer during the first time window; and
in response to the first velocity falling within a threshold velocity range during the first time window and in response to detecting the first engine speed within a threshold engine speed range during the first time window:
interpreting a first intent at the tow vehicle to maintain the first velocity; and
wherein setting the second motor torque output at the trailer motor for the second time window comprises:
in response to interpreting the first intent at the tow vehicle to maintain the first velocity during the first time window:
setting the second motor torque output, exceeding the first motor torque output by less than a threshold difference, for the second time window.

9. The method of claim 8, further comprising, during a fourth time period succeeding the third time period:
accessing a fourth deceleration and a fourth incline angle of the trailer during a fourth time window;
estimating a fourth passive deceleration component of the fourth deceleration based on the fourth incline angle;
calculating a fourth difference between the fourth passive deceleration component and the fourth deceleration; and
in response to the fourth passive deceleration component exceeding the fourth deceleration:
interpreting a fourth intent at the tow vehicle to accelerate; and
increasing motor torque output by the trailer motor proportional to the fourth difference.

10. The method of claim 8:
further comprising, during the first time period:
accessing a first signal output by a pressure sensor, coupled to a brake line of the trailer, during the first time window; and
detecting absence of a first change in brake line pressure in the brake line of the trailer based on the first signal;
wherein interpreting the first intent at the tow vehicle to maintain the first velocity during the first time window further comprises:
in response to absence of the first change in brake line pressure, interpreting the first intent at the tow vehicle to maintain the first velocity during the first time window; and
further comprising, during a fourth time period succeeding the third time period:
accessing a fourth deceleration and a fourth incline angle of the trailer during a fourth time window;
estimating a fourth passive deceleration component of the fourth deceleration based on the fourth incline angle;
accessing a fourth signal output by the pressure sensor during the fourth time window;
detecting a fourth change in brake line pressure in the brake line of the trailer based on the fourth signal; and
in response to the fourth deceleration exceeding the fourth passive deceleration component and in response to detecting the fourth change in brake line pressure:
interpreting a fourth intent at the tow vehicle to decelerate; and
increasing regenerative braking by the trailer motor.

11. The method of claim 1:
wherein setting the first motor torque output at the trailer motor for the first time window comprises:
setting the first motor torque output at the trailer motor arranged in the drive system of the trailer and coupled to a driven axle of a bogie of the trailer, the drive system of the trailer comprising the trailer motor, the driven axle, and the bogie;
wherein accessing the first net energy consumption from the battery of the trailer during the first time window comprises:
accessing the first net energy consumption from the battery configured to:
supply electrical energy to the trailer motor to drive the driven axle; and
receive electrical energy from the trailer motor during regenerative braking of the driven axle by the trailer motor; and
wherein accessing the first fuel consumption of the tow vehicle engine during the first time window comprises accessing the first fuel consumption wirelessly broadcast by
an external communication adapter connected to a data port of the tow vehicle.

12. A method comprising:
during a first time period:
accessing a first motor torque output by a trailer motor, arranged in a drive system of a trailer pulled by a tow vehicle, for a first time window;
accessing a first engine speed of a tow vehicle engine of the tow vehicle during the first time window;
calculating a first efficiency metric of the tow vehicle and the trailer during the first time window;
accessing a three-dimensional virtual surface relating motor torque outputs at the trailer motor, engine speeds of the tow vehicle engine, and efficiency metrics of the tow vehicle and the trailer;
projecting the three-dimensional virtual surface into a first two-dimensional virtual curve relating motor torque outputs and efficiency metrics at the first engine speed of the tow vehicle engine; and
in response to the first efficiency metric falling below a first peak efficiency for the tow vehicle and the trailer for the first engine speed:
calculating a first target motor torque output for the first engine speed based on the first two-dimensional virtual curve; and
in response to the first motor torque output falling below the first target motor torque output:
based on the first two-dimensional virtual curve, calculating a second motor torque output, greater than the first motor torque output, for the trailer motor for a second time window; and
during a second time period succeeding the first time period:
accessing a second engine speed, different from the first engine speed, of the tow vehicle engine during the second time window;
calculating a second efficiency metric of the tow vehicle and the trailer during the second time window;
projecting the three-dimensional virtual surface into a second two-dimensional virtual curve relating motor torque outputs and efficiency metrics at the second engine speed of the tow vehicle engine; and
in response to the second efficiency metric falling below a second peak efficiency for the tow vehicle and the trailer during for the second engine speed:
calculating a second target motor torque output for the second engine speed based on the second two-dimensional virtual curve; and
in response to the second motor torque output exceeding the second target motor torque output:
based on the second two-dimensional virtual curve, calculating a third motor torque, less than the second motor torque output, for the trailer motor for a third time window.

13. The method of claim 12, further comprising:
during the first time period, generating a first object comprising:
the first motor torque output at the trailer motor;
the first efficiency metric of the tow vehicle and the trailer; and
the first engine speed of the tow vehicle engine;
accessing a set of objects comprising the first object; and
generating the three-dimensional virtual surface interpolated between combinations of motor torque output at the trailer motor, engine speed of the tow vehicle engine, and efficiency metrics of the tow vehicle and the trailer represented by each object in the set of objects.

14. The method of claim 12:
further comprising, during the first time period, accessing a first velocity of the tow vehicle during the first time window; and
wherein calculating the second motor torque output for the trailer motor for the second time window comprises:
based on the first two-dimensional virtual curve, calculating a second engine speed for the tow vehicle engine and the second motor torque output for the trailer motor for the second time window;
interpreting a gear position for a transmission of the tow vehicle for the second time window, the gear position predicted to yield the second engine speed at the first velocity;
generating a notification prompting the tow vehicle to maintain the first velocity and upwardly shift the transmission to the gear position for the second time window; and
serving the notification to the tow vehicle.

15. The method of claim 14:
further comprising, during the first time period:
estimating a total torque for the tow vehicle and the trailer to maintain a first velocity of the trailer during the first time window based on:
a first incline angle of the trailer during the first time window;
the first velocity;
a total weight of the tow vehicle and the trailer; and
a cross-sectional area of the tow vehicle;
estimating a second engine torque output by the tow vehicle engine during the second time window following upshift to the gear position; and
calculating the second motor torque output based on a difference between the second total torque and the second engine torque output; and
wherein prompting the tow vehicle to maintain the first velocity and upwardly shift the transmission to the gear position comprises:
in response to the second motor torque output falling below a maximum torque capacity of the trailer motor, prompting the tow vehicle to maintain the first velocity and upwardly shift the transmission to the gear position for the second time window.

16. The method of claim 12:
wherein calculating the second motor torque output for the trailer motor for the second time window comprises:
selecting the second motor torque output from a torque range predicted to yield efficiency metrics of the tow vehicle and the trailer within a target efficiency metric range for the first engine speed; and
further comprising, during a third time period succeeding the second time period:
calculating a third efficiency metric of the tow vehicle and the trailer during the third time window; and
in response to the third efficiency metric falling below the second efficiency metric:
setting a fourth motor torque output by the trailer motor, the fourth motor torque output within the torque range and different from the third motor torque output.

17. The method of claim 12:
further comprising, during the first time period:
accessing a first velocity of the tow vehicle during the first time window; and
in response to the first velocity falling within a threshold velocity range during the first time window and in response to the first engine speed falling within a threshold engine speed range during the first time window:
interpreting a first intent at the tow vehicle to maintain the first velocity; and
wherein calculating the second motor torque output for the trailer motor for the second time window comprises:
in response to interpreting the first intent at the tow vehicle to maintain the first velocity, calculating the second motor torque output for the trailer motor for the second time window.

18. The method of claim 12:
wherein setting the first motor torque output at the trailer motor for the first time window comprises:
setting the first motor torque output at the trailer motor arranged in the drive system of the trailer and coupled to a driven axle of a bogie of the trailer, the drive system of the trailer comprising the trailer motor, the driven axle, and the bogie; and
wherein accessing the first engine speed of the tow vehicle engine during the first time window comprises accessing the first engine speed wirelessly broadcast by an external communication adapter connected to a data port of the tow vehicle.

19. A system comprising:
a driven axle configured to install on a trailer pulled by a tow vehicle;
a trailer motor coupled to the driven axle and configured to:
output torque to the driven axle; and
regeneratively brake the driven axle;
a battery configured to:
install on the trailer;
supply electrical energy to the trailer motor to drive the driven axle; and
receive electrical energy from the trailer motor during regenerative braking of the driven axle by the trailer motor;
an external communication adapter:
connected to a data port of the tow vehicle; and
configured to wirelessly broadcast operational data of a tow vehicle engine of the tow vehicle; and
a controller configured to:
access an engine speed of the tow vehicle engine from the external communication adapter;
access a three-dimensional virtual surface relating motor torque outputs at the trailer motor, engine speeds of the tow vehicle engine, and efficiency metrics of the tow vehicle and the trailer;
identify a target motor torque output for the engine speed based on the three-dimensional virtual surface; and
trigger the trailer motor to increase torque output toward the target motor torque output.

20. The system of claim 19, wherein the controller is configured to:
access a velocity of the trailer during a time window;
in response to the velocity falling within a threshold velocity range during the time window and in response to detecting the engine speed within a threshold engine speed range during the time window, interpret an intent at the tow vehicle to maintain the velocity; and
in response to interpreting the intent at the tow vehicle to maintain the velocity, trigger the trailer motor to increase torque output toward the target motor torque output.
